(19) United States
(12) Patent Application Publication
(10) Pub. No.: US 2016/0162819 A1
(43) Pub. Date: Jun. 9, 2016

(54) WORKFLOW DEFINITION, ORCHESTRATION AND ENFORCEMENT VIA A COLLABORATIVE INTERFACE ACCORDING TO A HIERARCHICAL PROCEDURE LIST

(71) Applicant: Hakman Labs LLC, Larkspur, CA (US)

(72) Inventors: Kevin David Hakman, Larkspur, CA (US); Howard Stewart Weingram, Los Altos, CA (US)

(21) Appl. No.: 14/957,145

(22) Filed: Dec. 2, 2015

Related U.S. Application Data
(60) Provisional application No. 62/087,168, filed on Dec. 3, 2014.

(51) Int. Cl. G06Q 10/06

(52) U.S. Cl. CPC G06Q 10/0633

(57) ABSTRACT

Various embodiments include a server system that parses a natural language text segment representative of a hierarchical checklist to generate a hierarchical workflow execution model. The hierarchical workflow execution model describes a plurality of task items corresponding to one or more line items in the natural language text segment. At least some of the task items can be respectively assigned to one or more participant roles according to the natural language text segment. Textual tokens of the line items can denote a hierarchical relationship structure of the task items. The server system can determine a logical constraint associated with enforcement of the task items based at least partly on the hierarchical relationship structure of the task items. The server system can enforce execution of at least a subset of the task items according to the determined logical constraint.

### CROSS-REFERENCE TO RELATED APPLICATION(S)

This application claims the benefit of U.S. Provisional Patent Application No. 62/087,168, entitled “WORKFLOW DEFINITION, ORCHESTRATION AND ENFORCEMENT VIA A COLLABORATIVE INTERFACE ACCORDING TO A HIERARCHICAL PROCEDURE LIST,” which was filed on Dec. 3, 2014, which is incorporated by reference herein in its entirety.

### TECHNICAL FIELD

At least one embodiment of this disclosure relates generally to a workflow management system.

### BACKGROUND

Existing workflow management tools are insufficient for today's workspace. For example, companies traditionally rely on standard operating procedures (SOPs) documented in company-wide or team-wide reference manuals. It is common for organizations to reference such manuals to train its working professionals. However, such reference manuals, whether in paper or digital form, do not facilitate the actual performance of the activities. The reference manuals are also slow to change and cannot dynamically adapt to variations.

Existing workflow management tools also include a conventional workflow management system implemented by a computer. The conventional workflow management system can be a software system for the setup, performance and monitoring of a collection of tasks and decision gates, organized as a workflow. However, these conventional workflow management systems present interfaces that require trained information technology (IT) professionals to configure the workflow management system to facilitate the desired team-wide procedures. This is inefficient for working professionals who conceive the desired business process because the dependency upon IT professionals both increases costs to implement and maintain the automated workflows over time and creates labor availability bottlenecks which slow initial implementation and future changes. The programming and configuration of the workflow data structure requires highly specialized knowledge, is time-consuming and is relatively expensive. Because changes to the team-wide procedures again require engagement with the skilled IT professionals, the conventional workflow management systems are slow to adapt to dynamic workflow evolutions. These conventional workflow management system are often so slow to adapt to the businesses needs that the workflow system is abandoned or not used for more procedures that are dynamic or require variation to facilitate the business needs.

Other tools, computer-implemented or otherwise, have been relied on by working professionals and companies for task management. For example, a simple form of task management involves a manager writing a “to do” list on paper, a whiteboard or on a digital format and sharing it over a network (e.g., using a shareable data storage space or a messaging system, such as email, etc.). The “to do” list, can characterize tasks that need to be done. Working professionals can even share the “to do” list on a wiki (i.e., a website that allows collaborative editing of its content by its users). This enables members of the team to view and update the “to do” list in a dynamic fashion. However, a “task list” or a “to do” list is not constructed to enforce the logic of certain procedures. While tasks might be grouped together to connote an order, a task list is nevertheless a passive data structure that is incapable of actual enforcement of the order, hierarchical conditions of accomplishing certain tasks, and assignment of tasks.

### DISCLOSURE OVERVIEW

Disclosed is a method of orchestrating and facilitating collaborative work among one or more actors performing procedures according to logical interdependencies embodied in hierarchical lists of activities. Several embodiments include a collaborative workflow system that includes a collaborative hierarchical list editor and a workflow orchestration engine. The collaborative workflow system can facilitate the definition, orchestration, and enforcement of a workflow via a hierarchical checklist. The collaborative workflow system overcomes the lack of process management automation of SOP manuals, the unenforceability of activity sequences and dependencies within “to do” lists, and the process inflexibility and IT bottlenecks of workflow management systems. In some embodiments, the collaborative hierarchical list editor generates a collaborative user interface to define or edit one or more hierarchical checklists. The hierarchical checklists are convenient for ordinary (e.g., non-IT) professionals to use because its creation is based on a natural language formatted to a convention enforced by the collaborative user interface.

In some embodiments, a hierarchical checklist list can include or be a flat list of non-sequential tasks. In some embodiments, a hierarchical checklist list can include or be a flat list of sequential tasks. That is, the hierarchy of the checklist can have one (e.g., in a flat list) or more levels (e.g., in a multi-level list) aside from the root level (e.g., the level representing the whole list).

The workflow orchestration engine is configured to interpret the hierarchical checklists to orchestrate (e.g., delegate, assign, and enforce) the indicated procedures described in natural language (e.g., using symbols, such as bullet points and numerals, that are natural to a human language and common to the formatting of information within documents used by non-IT people, such as “to do” lists and SOP manuals). The workflow orchestration engine can add features to enforce a workflow represented by the hierarchical checklist directly to the same hierarchical procedural list shown on the collaborative user interface. Multiple computing devices can access the hierarchical checklist via the collaborative user interface. However, one or more interactive objects in the collaborative user interface may be modified or constrained (e.g., prevented from being edited or interacted with) according to the implicit or explicit rules embodied within the hierarchical checklist (e.g., according to an assignment of task dictated by the hierarchical checklist or sequence of tasks dictated by symbols in the hierarchical checklist).

Defining standard operating procedures are widely seen as effective business management methods. However, in the modern day working environment, operating procedures evolve frequently or fail to anticipate variations to the SOP that can arise in special or nuanced circumstances. Hence, frequent variations from standard procedures or definition of detail procedures in an ad-hoc fashion can be essential to manage tasks for a project or an instance of a process. For example, when on-boarding employees typical steps are followed for most new hires. However certain employees might originate from countries wherein the standard hiring steps have to be varied or augmented to handle special visas, work permits, and unanticipated bureaucratic procedural requirements. The disclosed collaborative workflow system enables a team to handle varying working conditions in a managed, trackable and systematic manner.

The use of “standard operating procedures” can boost the productivity of teams of people, who will perform those procedures. Following the SOPs can potentially decrease the error and rework rates of those procedures, and potentially boost the quality of the work produced. Teams of people performing work may define, at a moment of need, certain procedural steps and follow-up tasks to organize their near-term work (e.g., procedures which are not-standard operating procedures).

However, existing methods (e.g., the conventional workflow management system, the “to do” list, and the SOP manuals) are generally insufficient to efficiently handle the management, monitoring and performance of such procedures within convenience and risk tolerances acceptable to business users. For example, high volume car loan processing has a SOP. In this example, it is desirable no limit all variation as a means to reduce risks. However in contrast, hiring new employees has a SOP, but allowing users to create variation is desired to avoid the time and money cost of engaging IT to implement the variation route in traditional workflow. In this case, the users are trusted to “do the right thing” to get the employee hired. Without a flexible workflow system like the hierarchical checklist, the team would just use email to facilitate the collaboration. However, email for such use cases is inefficient, cumbersome to understand what the “most current state of information” is, and prone to users referencing non-current information (e.g., email attachment files or other information shared over email). The inefficiencies are amplified when some tasks are conditional tasks. A first task may need to be completed by a first team member before a second task can be completed by a second team member. For example, a team member cannot build a product until another team member designs the product. For another example, a team member cannot bill for a logistic transaction until another team member verifies shipment. For yet another example, a team member cannot send out a sales quote until another member has reviewed and/or approved the sales quote.

In many situations, variants on SOPs are necessary to perform nuanced work. For example, there is a standard procedure to facilitate the sale of a home, but variation must be possible to handle cases, such as special concerns about a property (e.g., potential pre-existing land contamination issues, permits, or other non-standard contingencies critical to completing the sale).

The collaborative workflow system utilizes a hierarchical checklist of work/procedural items to enable: (a) one or more people to define a procedure as a hierarchical checklist; (b) one or more people to read and understand the steps of the procedure and the actors performing aspects of the hierarchical checklist; (c) one or more people to update their assigned aspects of the hierarchical checklist; and (d) participants in the process to be allowed to perform the work in the hierarchical checklist. The workflow orchestration engine can facilitate the assignment of work and management of decision gates for the procedure according to relationships and conditions interpreted from the hierarchical checklists' structure and attributes. A hierarchical checklist can define at least: (a) a hierarchy of parent/child relationships between objects (e.g., tasks, steps, explanations, notes) in the procedure list; (b) the specialized symbols (e.g., numbered bullets) denoting elements within the hierarchy numbered to direct sequential execution; (c) generic symbols (e.g., round bullet points) to allow parallel execution, (d) other specialized graphical symbols for other specialized behaviors (e.g., a decision gate like “approve or deny;” (e) an activity to attach a file or enter data, which can then optionally be used in other decision gates; (f) informational notes that are not intended as work items requiring completion; or any combination thereof. An author can also indicate attributes in the hierarchical checklist via the collaborative hierarchical list editor. For example, the attributes can include who will be the actor to which the work will be assigned when a time schedule or a condition is met (e.g., as opposed to immediately assigned). An author can also indicate the method for determining who the actor(s) will be, the due date or time allowance for the performance of the work, etc.

The collaborative hierarchical list editor enables process participants (e.g., one or more authors and/or one or more actors) to perform work in the context of the procedure definition. The workflow orchestration engine can interpret the defined procedures in a natural language known to the authors and orchestrate the enforcement of the procedures via its own messaging interface or the collaborative user interface of the collaborative hierarchical list editor. In several embodiments, the workflow orchestration engine can parse the hierarchical checklist defined in the natural language to configure the collaborative user interface also as a workflow enforcement interface as well as a hierarchical checklist editor. In some embodiments, more than one natural language can be used such that different natural language inputs can be captured, parsed, interpreted, generated, enforced and/or displayed so as to facilitate collaboration among a team that uses different natural languages. That is, the interface to define the hierarchical checklist can be substantially the same interface to enforce the hierarchical checklist.

The features in several embodiments are advantageous at least because the collaborative workflow system enables greater convenience to non-IT trained users than the traditional workflow management system that depends on skilled IT professionals to program in a workflow enforcement interface to manage activities for team members. These features are also advantageous for enabling greater flexibility in editing and creating variations as needed of the workflow without the involvement of the skilled IT professionals.

As compared to “to do” lists and task lists, which are loosely structured depending on its author, several embodiments provide greater process enforcement, structured task verification and assignment of tasks to users when appropriate (e.g., rather than all up-front or manually assigned when a person and rather than an engineer deciding it is time to assign the next tasks). The collaborative user interface generated by the collaborative hierarchical list editor can error check and highlight keywords in a natural language to facilitate authors to design the hierarchical checklist in a predictable manner. In some embodiments, while the author is designing the hierarchical checklist, the workflow orchestration engine can, in real-time, facilitate the enforcement of the hierarchical checklist even before the author completes the hierarchical checklist.

In several embodiments, the workflow orchestration engine provides enforcement of tasks and verification of completion in ways that other communication (e.g., email, text messaging, chat, other messaging application(s), etc.) or collaboration tools (e.g., shared storage space or shared productivity suite) cannot. The structure of the hierarchical checklist also enables task enforcement automation orchestrated by the computer system that is otherwise unavailable to conventional communication or collaboration tools that merely describes a workflow procedure.

In several embodiments, the workflow orchestration engine enables an end user to conceptually “go back” or “delegate” or take other action, which results in a “rolling back” of work done within the hierarchical checklist or just-in-time amendment to the hierarchical checklist to facilitate the additional needs. This way, variations to standard processes embodied in a hierarchical checklist can be facilitated by the workflow orchestration engine because the workflow orchestration engine can enable end users to adapt the hierarchical checklist when needed (without having to get an IT person/workflow programmer) to do it for them. Such deviations or amendments to standard procedures could be detected by the workflow orchestration engine and automatically escalated to a process manager for approval.

Personal or even collaborative task lists are lists of tasks, at times grouped into collections. The disclosed hierarchical checklist differs in that the sequence of activities in the hierarchical checklist matters—it provides context for what must happen in what sequence for the process to advance. The personal task lists are lists organized by the end user (e.g., an actor) into the ad-hoc sequence that reflects the end-user's priorities as opposed to the prioritized sequence of the overall process (e.g., as dictated by a collaborative effort of authors). Utility is achieved because the prioritized sequence enables a machine to analyze the activities done and/or to be done in the context of an overall process—something that is difficult to do for other solutions that merely issue tasks and group like-kind together into collections.

Some embodiments of this disclosure have other aspects, elements, features, and steps in addition to or in place of what is described above. These potential additions and replacements are described throughout the rest of the specification

### BRIEF DESCRIPTION OF THE DRAWINGS

FIG. 1 is a block diagram illustrating a collaborative workflow system, in accordance with various embodiments.

FIG. 2 is an illustration of examples of collaborative user interfaces generated by a collaborative hierarchical list editor, in accordance with various embodiments.

FIG. 3 is a flow chart illustrating an example process of operating the collaborative workflow system, in accordance with various embodiments.

FIG. 4 is a block diagram of an example of a computing device, which may represent one or more computing devices or servers described herein, in accordance with various embodiments.

FIGS. 5A-5E are additional examples of the collaborative user interface generated by the collaborative hierarchical list editor, in accordance with various embodiments.

FIG. 6 is a block diagram of a workflow orchestration server system, in accordance with various embodiments.

FIG. 7 is a method of operating a collaborative workflow system to define a workflow associated with a hierarchical checklist, in accordance with various embodiments.

FIG. 8 is a method of operating a collaborative workflow system to execute a workflow associated with a hierarchical checklist, in accordance with various embodiments.

FIG. 9 is a method of operating a collaborative workflow system to manage hierarchical checklist templates, in accordance with various embodiments.

The figures depict various embodiments of this disclosure for purposes of illustration only. One skilled in the art will readily recognize from the following discussion that alternative embodiments of the structures and methods illustrated herein may be employed without departing from the principles of embodiments described herein.

### DETAILED DESCRIPTION

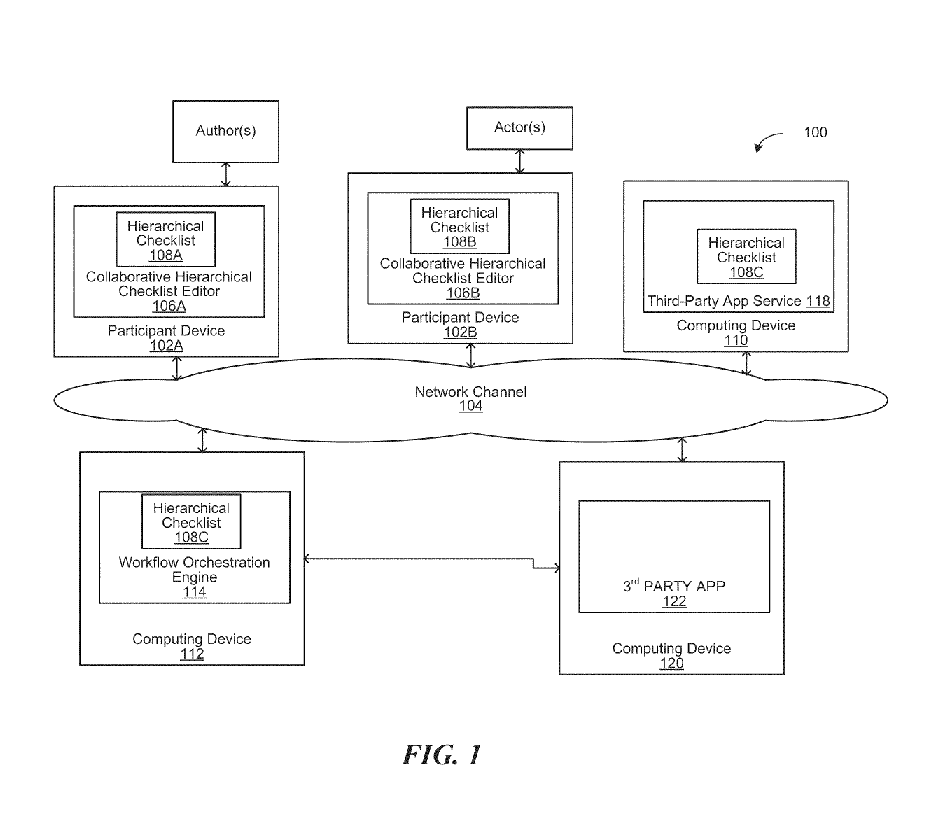

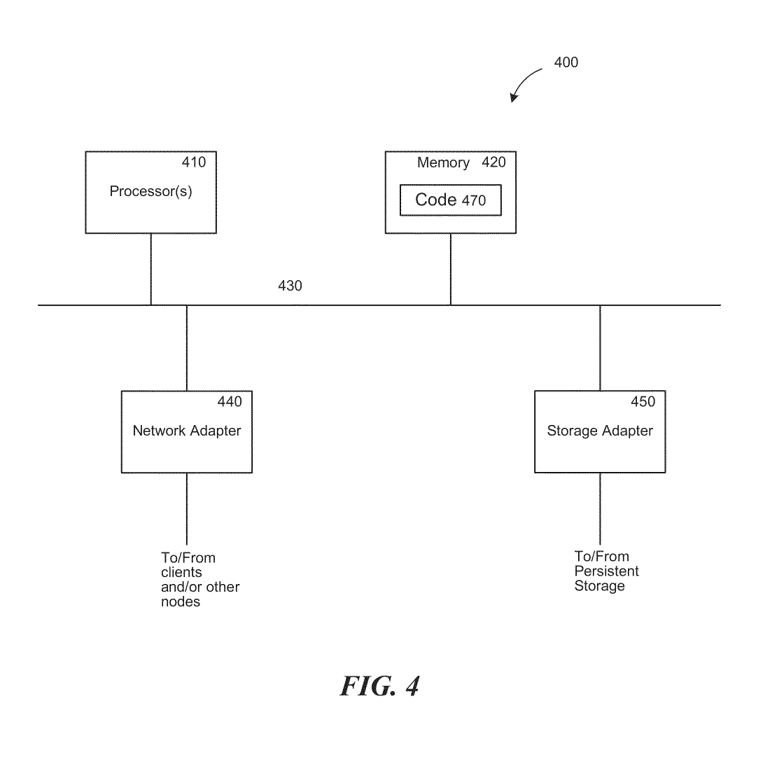

FIG. 1 is a block diagram illustrating a collaborative workflow system 100, in accordance with various embodiments. The collaborative workflow system 100 includes one or more participant devices (e.g., a participant device 102A and a participant device 102B, collectively as the “participant devices 102”). The participant devices 102 can be computing devices, such as one or more of the computing device 400 of FIG. 4. The participant devices 102 can be operated by an author of a hierarchical checklist or an actor who receives instructions from the hierarchical checklist and executes tasks enforced by the hierarchical checklist. An author in the collaborative workflow system 100 can also be an actor in the collaborative workflow system 100.

The participant devices 102 can communicate over a network channel 104, such as a local area network (LAN) or a wide area network (WAN). The participant devices 102 can communicate with each other and/or with a computing device 112, such as the computing device 400, which implements a workflow orchestration engine 114. The computing device 112 can be a cloud-based workflow server in communication with the participant devices 102 over the network channel 104.

Each of the participant devices 102 can implement an instance of a collaborative hierarchical list editor (e.g., an editor instance 106A in the participant device 102A or an editor instance 106B in the participant device 102B, collectively or individually as the “collaborative hierarchical list editor 106”). The collaborative hierarchical list editor 106 can be an application running on a computing device. The collaborative hierarchical list editor 106 can generate a collaborative user interface to view or edit all or portions of one or more hierarchical checklists, such as a hierarchical checklist 108 (e.g., a procedure list instance 108A maintained by the editor instance 106A or a procedure list instance 108B maintained by the editor instance 106B, collectively or individually as the “hierarchical checklist 108”). For example, determination of which portion(s) can be a function of the current state of the hierarchical checklist, the current participant using the collaborative hierarchical list editor 106 to access the hierarchical checklist, or other data available to the participant device 102A or 102B and/or the workflow orchestration engine 114. The workflow orchestration engine 114 can implement artificial intelligence that analyzes the hierarchical structure of the hierarchical checklist and other factors to determine which portions are editable under what conditions. This artificial intelligence enables the collaborative workflow system 100 to automate workflow assignment, tracking, processing, and/or enforcement.

In some embodiments, the collaborative hierarchical list editor 106 may run on a participant device as an application or may run within an intermediary environment on the participant device (e.g., a web browser, a virtual machine, a JVM, or other virtual computing space running on the participant device). In some embodiments, the participant devices are virtual environments, such as browsers, virtual machines, or other containers within which the collaborative hierarchical list editor 106 can run (e.g., with or without installation).

For example, the collaborative hierarchical list editor 106 can facilitate data capture as part of the authorship in creating the hierarchical checklist 108. Data capture methods can include taking a photo, using device sensors or other data entry methods to capture information related to the procedure represented by the hierarchical checklist 108, using an electronic form, or any combination thereof. The collaborative hierarchical list editor 106 can also facilitate execution of a machine implemented activity as dictated by the hierarchical checklist 108. For example, the collaborative hierarchical list editor 106 can invoke the API of a third-party application or a third-party application service to perform an aspect of the workflow represented by the hierarchical checklist 108.

The hierarchical checklist 108 is a list written in a natural language according to a template structure. The hierarchical checklist 108 can denote conditional relationships, sequential relationships, non-sequential relationships, schedules, assignments, and/or other criteria of defining or enforcing work tasks utilizing symbols (e.g., numeric symbols, bullet symbols, etc.) and/or words in the natural language. In some embodiments, the collaborative user interface can enforce the template structure whenever an author deviates from the template structure. In some embodiments, an author can request the collaborative hierarchical list editor 106 to pre-populate the hierarchical checklist 108 in accordance with a SOP. The author can then modify the hierarchical checklist 108 according to the specific needs of an instance of a process.

When a computing device maintaining an instance (e.g., the procedure list instance 108A or the procedure list instance 108B) of the hierarchical checklist 108 has a connection to the network channel 104, the collaborative hierarchical list editor 106 can update, in real-time, the hierarchical checklist instance with a master instance 108C maintained by the workflow orchestration engine 114. Whenever a connection to the network channel 104 is unavailable, individual hierarchical checklist instance may deviate from each other and from the master instance 108C. At a later time when connection becomes available, the collaborative hierarchical list editor 106 can check in its hierarchical checklist instance to the workflow orchestration engine 114.

The hierarchical checklist 108 can be a representation of a multi-actor, multistep process (e.g., a workflow) designed to be executed by a machine capable of performing or delegating (e.g., to other machines or humans) the process activities (e.g., work items). The hierarchical checklist 108 distinguishes from diagrams or workflow code authored by IT professionals who are trained to use conventional workflow management systems. That is, the written workflow code does not resemble the user interface for working with the workflow by the actors of the workflow. Similarly, the diagram elements do not resemble the user interface for working with the workflow by the actors of the workflow.

Edits can be merged with the master instance 108C, with or without approval, depending on authority setting associated with the hierarchical checklist 108. Multiple authors can edit the hierarchical checklist 108. One or more “owners” can be associated with every hierarchical checklist, such as the hierarchical checklist 108. The owners can have the authority to edit settings (e.g., authority settings of the authors and actors) associated with hierarchical checklist.

In several embodiments, third-party applications and application services can interface with the workflow orchestration engine 114 and/or the collaborative hierarchical list editor 106. For example, a computing device 110 (e.g., a mobile device, a computer server, a laptop or desktop computer, a network connected device which includes a computer, etc.) can implement and execute a third-party application service 118. In some embodiments, the third-party application service 118 can provide an application programming interface (API) for the collaborative hierarchical list editor 106 or the workflow orchestration engine 114 to access. In some embodiments, the third-party application service 118 can include an API adapter to access the API of the workflow orchestration engine 114. For another example, a computing device 120 (e.g., a mobile phone, a wearable device, a laptop, a desktop computer, or other mobile or stationary computer) can execute a third-party application 122. The third-party application 122 can have an API adapter to interface with an API of the collaborative hierarchical list editor 106 and/or the workflow orchestration engine 114.

Bulleted lists are typically made for human readability and not machine execution. The workflow orchestration engine 114 introduces the concept of bulleted lists composed of a hierarchy of line items wherein each line item can have one or more denoted attributes such that the bulleted lists can be (A) authored by a non-developer, (B) understood by a non-developer, and (C) the capable of being interpreted by the workflow orchestration engine 114 so as to facilitate execution of the process by one or more actors to perform activities are delegated. The form of the process instructions sent to the workflow orchestration engine 114 is the form of the user interface with which a human interacts to author the process instructions and to view information regarding delegated tasks. In some embodiments, the form of the process instructions can be mutated by a human mid process during execution and the workflow orchestration engine 114 can orchestrate the mutated process in real-time in response to the change/mutation. In some embodiments, the representation of the procedural steps that are machine interpretable are also the user interface through which a person can interact with the process/workflow and discover/comprehend the context of steps and information within which they are taking action.

In some embodiments, steps of a procedure/workflow represented by the hierarchical checklist 108 may be applicable if certain conditions are met. As such, a bullet representing a work item in the hierarchical checklist may be preceded by a conditional statement which the workflow orchestration engine 114 can evaluate. The work item would only be applicable if the conditional statement proved to be a certain value (e.g., true). Accordingly, the workflow orchestration engine 114 can instruct the collaborative hierarchical list editor 106 to prevent any interactions with the work item on the collaborative user interface until the conditional statement is satisfied.

In some embodiments, the workflow orchestration engine 114 can assign work items to people, machines, third-party applications, third-party application services, or any combination thereof. The workflow orchestration engine 114 can generate a workflow path with all its dependencies from the hierarchical checklist 108. The workflow orchestration engine 114 can evolve the workflow path as the hierarchical checklist 108 is updated. The workflow orchestration engine 114 can send reminders of work items according to a schedule of the workflow path. The schedule can be a state machine, a timeline, a sequence, or any combination thereof. The workflow orchestration engine 114 can query actors for more information associated with work items, for completion status updates of work items, for approval indication associated with work items, or any combination thereof.

In some embodiments, the workflow orchestration engine 114 can keep analytics of the workflow path as the workflow path is enforced. For example, the workflow tracking is enforced by requesting information from the actors. Hence, the workflow orchestration engine 114 can include an analytics module. In some embodiments, the analytics engine can generate a timeline and/or progress report associated with the workflow path. In some embodiments, the analytics engine can identify the bottlenecks (e.g., a work item or an actor) of a workflow path. In some embodiments, the analytics engine can analyze (e.g., compare) documents attached to the hierarchical checklist as an indication of a completion of a work item. In some embodiments, the analytics module can generate an audit trail describing which actors accomplish what work items at what time. In some embodiments, the analytics module can identify a baseline progress timeline from data associated with a hierarchical checklist being performed over and over again. This enables the analytics module to detect real-time anomalies when enforcing the hierarchical checklist. This also enables the analytics module to detect flow inefficiencies and/or circular or illogical workflow paths. These features enable the analytics module to act as a machine advisor who can debug potential errors in an operating procedure defined by the hierarchical checklist.

In some embodiments, the workflow orchestration engine 114 can automatically change the permissions for an actor to act on the hierarchical checklist. For example, if a dependency of a work item is not yet accomplished, and actor assigned to the work item may be prevented from interacting with the hierarchical checklist.

Functional components (e.g., engines, modules, and APIs) associated with each of the computing devices in the collaborative workflow system 100 can be implemented as circuitry, firmware, software, or other functional instructions. For example, the functional components can be implemented in the form of special-purpose circuitry, in the form of one or more appropriately programmed processors, a single board chip, a field programmable gate array, a network-capable computing device, a virtual machine, a cloud computing environment, or any combination thereof. For example, the functional components described can be implemented as instructions on a tangible storage memory capable of being executed by a processor or other integrated circuit chip. The tangible storage memory may be volatile or non-volatile memory. In some embodiments, the volatile memory may be considered “non-transitory” in the sense that it is not a transitory signal. Memory space and storages described in the figures can be implemented with the tangible storage memory as well, including volatile or non-volatile memory.

Each of the functional components may operate individually and independently of other functional components. Some or all of the functional components may be executed on the same host device or on separate devices. The separate devices can be coupled through one or more communication channels (e.g., wireless or wired channel) to coordinate their operations. Some or all of the functional components may be combined as one component. A single functional component may be divided into sub-components, each sub-component performing separate method step or method steps of the single component.

In some embodiments, at least some of the functional components share access to a memory space. For example, one functional component may access data accessed by or transformed by another functional component. The functional components may be considered “coupled” to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implements a portion of the functional components). The systems, engines, or devices described may include additional, fewer, or different functional components for various applications.

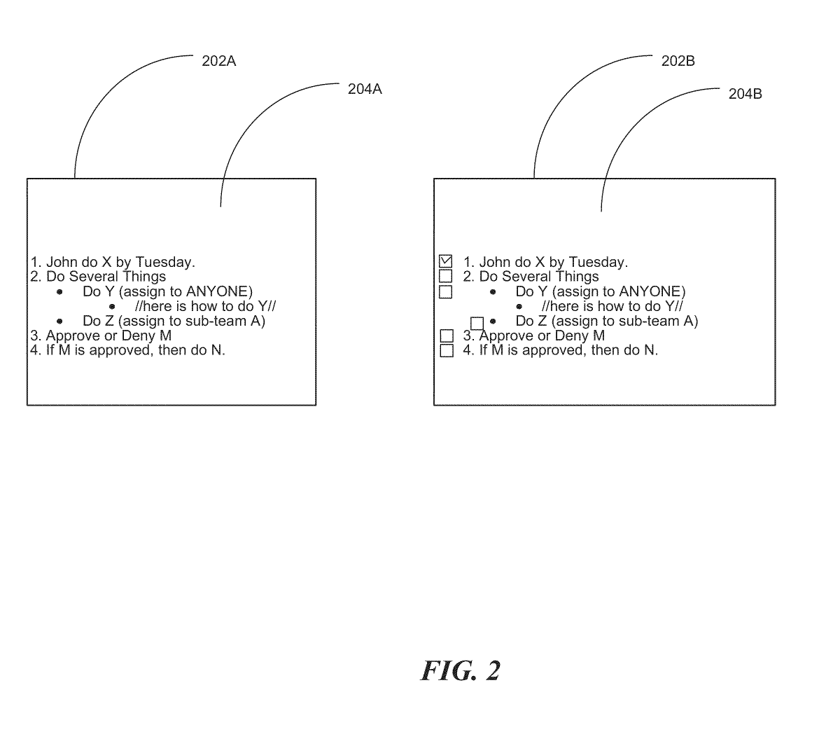

FIG. 2 is an illustration of examples of a collaborative user interface generated by a collaborative hierarchical list editor in various devices by various participants, in accordance with various embodiments. In a first example, an interface instance 202A of the collaborative user interface is provided for an author of a hierarchical checklist 204A. The interface instance 202A is an interactive text editing space. The interface instance 202A can be configured as an integrated development environment for structured/templated natural language. In some embodiments, some information in the hierarchical checklist 204A can be argumentative or instructive notes interspersed amongst the actionable and/or assignable steps (e.g., work items) in a procedure/workflow. For example, the comment “here is how to do Y” can be an instructive note instead of an actionable step. In some embodiments, unlike conventional task lists or “do to lists”, the label “2” gets automatically marked as “done” (e.g., by a check mark) by the workflow orchestration engine when “Do Y” and “Do Z” are both completed (e.g., as reported by a participant/actor or as determined computationally by the workflow orchestration engine). A task can be verified to be completed computationally by verifying whether a computer file is present, whether a file is uploaded, whether an email is sent, or by detecting a user verification of completion.

In some embodiments, the author can embed conditions in the hierarchical checklist 204A. For example, completion of a sub-list can trigger the start of another sub-list or another hierarchical checklist. In some cases, the conditions may include an approval from an actor designated in the hierarchical checklist. As such, broader procedures can be defined by defining the relationships between two or more procedural lists.

In a second example, an interface instance 202B of the collaborative user interface is provided for an actor of a hierarchical checklist 204B. In some cases, the actor may be restricted from further editing the hierarchical checklist 204B. In some cases, the actor may be allowed to add additional tasks without removing or modifying existing tasks. In some cases, the actor may be allowed to assign himself/herself a task or indicate that a task (e.g., assign or not) is completed or in progress. In some cases, the actor may be allowed to add text that will not be interpreted by the workflow orchestration engine. In some cases, the actor may be allowed to approve or deny a task to be performed (e.g., approving or denying task “M”). The workflow orchestration engine is responsible for communicating with the collaborative hierarchical list editor to determine what actions can be taken on the interface instance 202B.

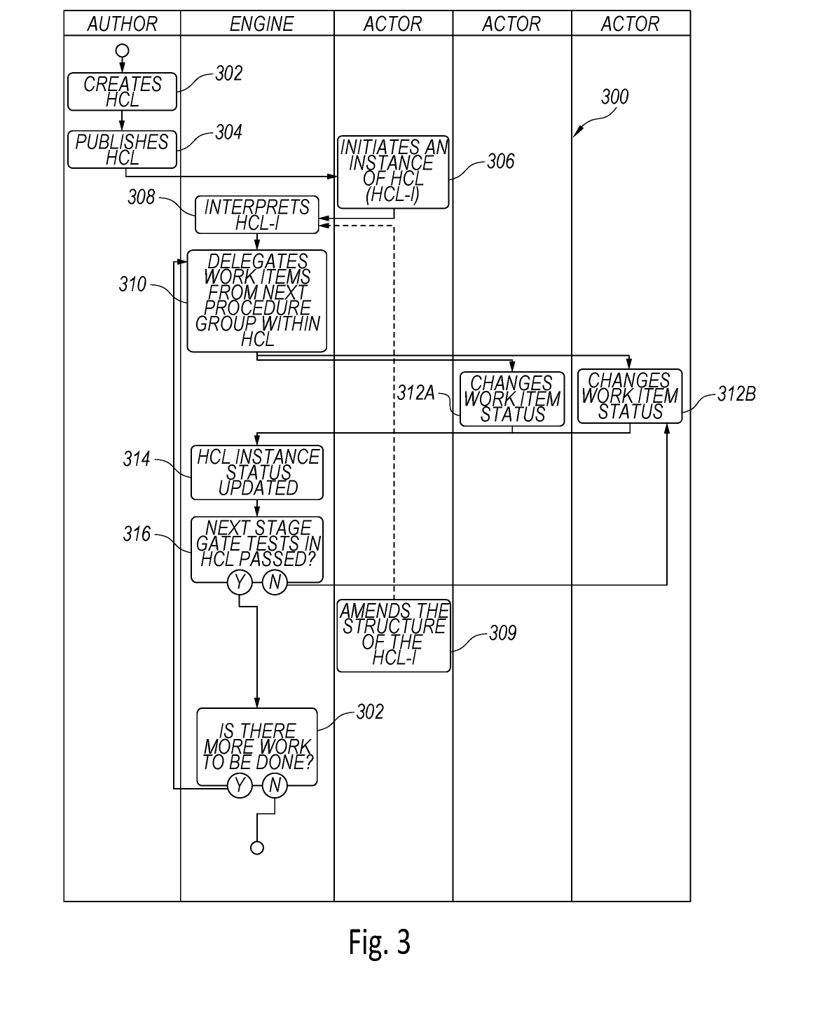

FIG. 3 is a flow chart illustrating an example process 300 of operating the collaborative workflow system, in accordance with various embodiments. An author creates, at step 302, a hierarchical checklist and publishes, at step 304, the hierarchical checklist (e.g., via the collaborative hierarchical list editor 106). In the flow chart, “HCL” refers to the hierarchical checklist, and HCL-I refers to an instance of the hierarchical checklist. At step 306, an actor can then instantiate an instance of the hierarchical checklist on its editor instance (e.g., the editor instance 106B). A workflow orchestration engine (e.g., the workflow orchestration engine 114) can maintain a master procedure list instance.

At step 308, the workflow orchestration engine can interpret the hierarchical checklist instance to make updates to the workflow represented by the master procedure list instance. The workflow orchestration engine can dynamically generate and update the necessary workflow states and paths according to the master procedure list instance. In some embodiments, at step 309, an actor (e.g., a participant) can amend the hierarchical checklist instance. When this occurs, step 309 can be repeated to re-interpret the hierarchical checklist instance. At step 310, the workflow orchestration engine can delegate work items following the workflow paths.

In some cases, other actors can change (e.g., step 312A or step 312B) a status of one or more work items. This can cause the workflow orchestration engine to again update, at step 314, the master procedure list instance and update the workflow state and paths. When the workflow state and paths is updated, the workflow orchestration engine can further delegate work items to other actors. In some cases, a stage gate may be defined in the hierarchical checklist. At step 316, the workflow orchestration engine can determine whether or not the stage gate has passed. If passed, the workflow orchestration engine can allow the workflow paths to continue until there is no more work to be done. For example, at step 318, the workflow orchestration engine can determine whether these are more work to be done.

In several embodiments, the example process 300 requires a network of computers. The features of the process 300 are enabled by a workflow orchestration engine that performs real-time construction of a workflow. The construction of the workflow may include parsing a data representation of natural language text (e.g., template to a format convention), interpreting the natural language text, and building a workflow path that can be enforced via one or more collaborative user interfaces (e.g., collaborative hierarchical list editor instances). In some embodiments, a technical feature of the workflow orchestration engine is that the source of the construction (e.g., bulleted lists in a natural language in a collaborative user interface) is also the result of the construction (e.g., machine controlled features on the bulleted lists). The network of computing devices enables a collaborative user interface for both defining and enforcing a hierarchical checklist representing a workflow to be simultaneously presented to multiple participating users. Enforcing, for example, can include recording or querying the progress of task item in a workflow path and preventing or enabling an actor to interact with one or more of the task items depending on the progress of the task items. The network of computing devices enables real-time collaborations across a large physical distance.

FIG. 4 is a block diagram of an example of a computing device 400, which may represent one or more computing device or server described herein, in accordance with various embodiments. The computing device 400 can be one or more computing devices in the collaborative workflow system 100 of FIG. 2. The computing device 400 can execute methods and processes described in this disclosure (e.g., the example process 300 of FIG. 3). The computing device 400 includes one or more processors 410 and memory 420 coupled to an interconnect 430. The interconnect 430 shown in FIG. 4 is an abstraction that represents any one or more separate physical buses, point-to-point connections, or both connected by appropriate bridges, adapters, or controllers. The interconnect 430, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or a “Firewire”.

The processor(s) 410 is/are the central processing unit (CPU) of the computing device 400 and thus controls the overall operation of the computing device 400. In certain embodiments, the processor(s) 410 accomplishes this by executing software or firmware stored in memory 420. The processor(s) 410 may be, or may include, one or more programmable general-purpose or special-purpose microprocessors, digital signal processors (DSPs), programmable controllers, application specific integrated circuits (ASICs), programmable logic devices (PLDs), trusted platform modules (TPMs), or the like, or a combination of such devices.

The memory 420 is or includes the main memory of the computing device 400. The memory 420 represents any form of random access memory (RAM), read-only memory (ROM), flash memory, or the like, or a combination of such devices. In use, the memory 420 may contain a code 470 containing instructions according to the mesh connection system disclosed herein.

Also connected to the processor(s) 410 through the interconnect 430 are a network adapter 440 and a storage adapter 450. The network adapter 440 provides the computing device 400 with the ability to communicate with remote devices, over a network and may be, for example, an Ethernet adapter or Fibre Channel adapter. The network adapter 440 may also provide the computing device 400 with the ability to communicate with other computers. The storage adapter 450 enables the computing device 400 to access a persistent storage, and may be, for example, a Fibre Channel adapter or SCSI adapter.

The code 470 stored in memory 420 may be implemented as software and/or firmware to program the processor(s) 410 to carry out actions described above. In certain embodiments, such software or firmware may be initially provided to the computing device 400 by downloading it from a remote system through the computing device 400 (e.g., via network adapter 440).

The computing device 400 can include one or more input devices (not shown) (e.g., keyboard, mouse, touchscreen, sensors, receivers, cameras, microphones, or any combination thereof). For example, the input devices can facilitate a user to interact with the collaborative interface generated by various embodiments. The computing device 400 can also include one or more output devices (not shown) (e.g., screens, displays, audio speakers, transmitters, printers, electronic papers, or any combination thereof). The output devices can facilitate the collaborative hierarchical list editor to display the hierarchical checklist.

The techniques introduced herein can be implemented by, for example, programmable circuitry (e.g., one or more microprocessors) programmed with software and/or firmware, or entirely in special-purpose hardwired circuitry, or in a combination of such forms. Special-purpose hardwired circuitry may be in the form of, for example, one or more application-specific integrated circuits (ASICs), programmable logic devices (PLDs), field-programmable gate arrays (FPGAs), etc.

Software or firmware for use in implementing the techniques introduced here may be stored on a machine-readable storage medium and may be executed by one or more general-purpose or special-purpose programmable microprocessors. A “machine-readable storage medium,” as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

The term “logic,” as used herein, can include, for example, programmable circuitry programmed with specific software and/or firmware, special-purpose hardwired circuitry, or a combination thereof.

### Technical Features of the Collaborative Workflow System

The technical features of the collaborative workflow system provide mechanisms that improve over conventional workflow management systems and conventional shared to do list. The collaborative workflow system provides utility by conflating the design of procedural representation within the use of the procedural representation. The data structure designed at author time in its form can simultaneously facilitate the collaborative execution of the process. The data structure can provide one or more users with a view into the constructed workflow path representing the process/procedure, the current state of the procedure, and actions they should or can take within that procedure. The workflow orchestration engine can facilitate the collaborative execution of the procedure.

The collaborative workflow system distinguishes from conventional workflow management systems by its use of the hierarchical checklists. In the conventional systems, authoring a workflow involves either (a) modeling a workflow diagram represented by boxes, nodes and/or lines, or (b) programming the workflow in a programming language designed for machine interpretation. Each of these methods can be sophisticated and nuanced and require training usually associated with the IT profession. Each of these methods result in a workflow model represented as a directed graph. A directed graph a data structure that consists of a finite set of nodes, together with a set of ordered paths between these nodes. These paths can be represented as arrows or directional edges. Both methods result in generating user interfaces to facilitate the work by participants who are different from IT professionals trained for diagramming or programming.

Unlike the conventional workflow management system, the disclosed hierarchical checklists represent steps in a procedure as bulleted items in a hierarchical list. A hierarchical checklist is used for both authoring the representation of a workflow and runtime workflow orchestration. The workflow orchestration engine can interpret the hierarchical checklist to represent the workflow and implement passive and/or interactive features in the hierarchical checklist to facilitate multiple participants to understand and perform the steps of the workflow in real-time over a computer network. The single representation of the workflow procedure for machine interpretable authorship, human interpretable authorship, and enforcement creates a process/workflow management environment that increases convenience and flexibility without relying on IT professionals. The various embodiments of the collaborative workflow system makes it easier and faster for more people who may not be trained in the art of implementing automated workflows to implement and change automated workflows and one-off variations of workflows as needed to suite then current business needs.

In various embodiments, a data structure (e.g., the hierarchical checklist) used to create and define a workflow can be the same data structure used to take action within an instance of the workflow. In some embodiments, the workflow orchestration engine can convert a hierarchical checklist to a machine interpretable format after authorship of a workflow for storage. In these embodiments, the workflow orchestration engine can convert the machine interpretable format back into a hierarchical checklist when enforcing a workflow execution. In several conventional workflow management systems, a first data structure is used to design a workflow for execution by a workflow engine and a different data structure is used to enforce workflow execution of an instance of the workflow.

The collaborative workflow system can also differentiate over conventional to shared do lists because of its inclusion of the workflow orchestration engine. The workflow orchestration engine operates over an information network to which the actors connect to receive work and update statuses of work items. The collaborative workflow system enables the actors to work at a distance, and thus alleviating the requirement to be physically present with the list of work to be done.

Conventional bulleted lists have been used to represent hierarchies of tasks to be completed. The nesting of line item tasks in such lists only connotes, but does not enforce, dependencies. The collaborative workflow system can enforce dependencies by:
using the inherent hierarchy to enforce dependencies (e.g., via logic within the workflow orchestration engine);
using numerically, alphabetically, or similarly sequential sets of bullets to enforce sequential execution or work (e.g., via logic within the workflow orchestration engine);
using non-sequential sets of bullets to allow non-sequential (thus potentially parallel) execution of work (e.g., via logic within the workflow orchestration engine); and
introducing specialized types of bullets for specialized types of behaviors, such as request for approvals or other type of decision gates (e.g., conditional gates).

A “to do” list of tasks, even if hierarchical, for one or more people to perform might have tasks arranged in groups, collections, hierarchies, or sequences. However, these solutions lack a central engine that can enforce procedural steps to be executed in dependent sequences. The order in which the tasks are to be performed might be connoted by the arrangement of the task list, but are not enforced by an orchestrating engine. The collaborative workflow system can indicate and enforce dependencies in a hierarchical manner (e.g., sub-lists having multiple levels and ancestry relationship), in a sequential manner (e.g., numbered bullets), in a conditional manner, or in a parallel manner.

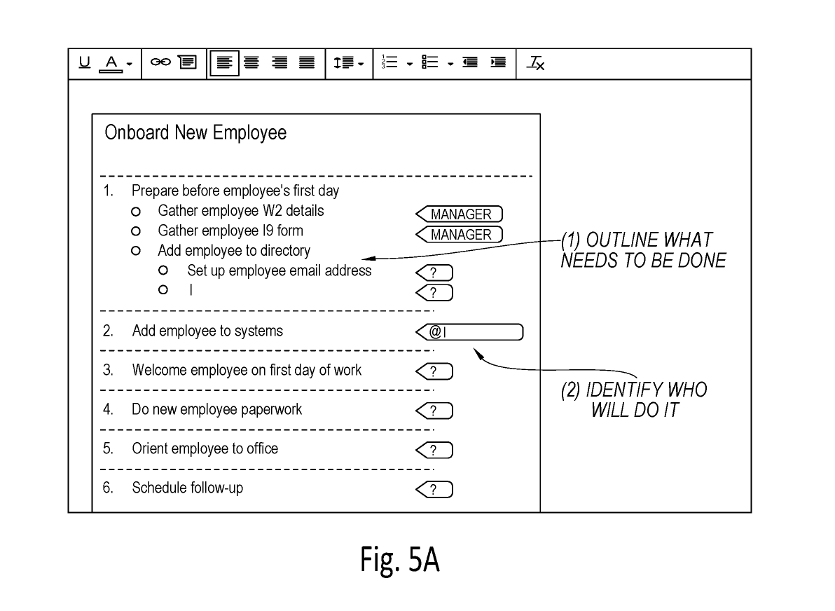

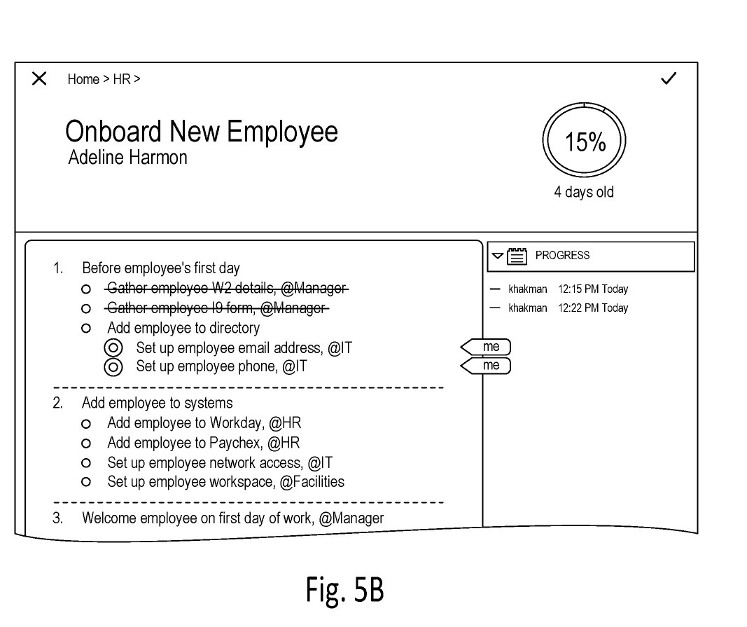

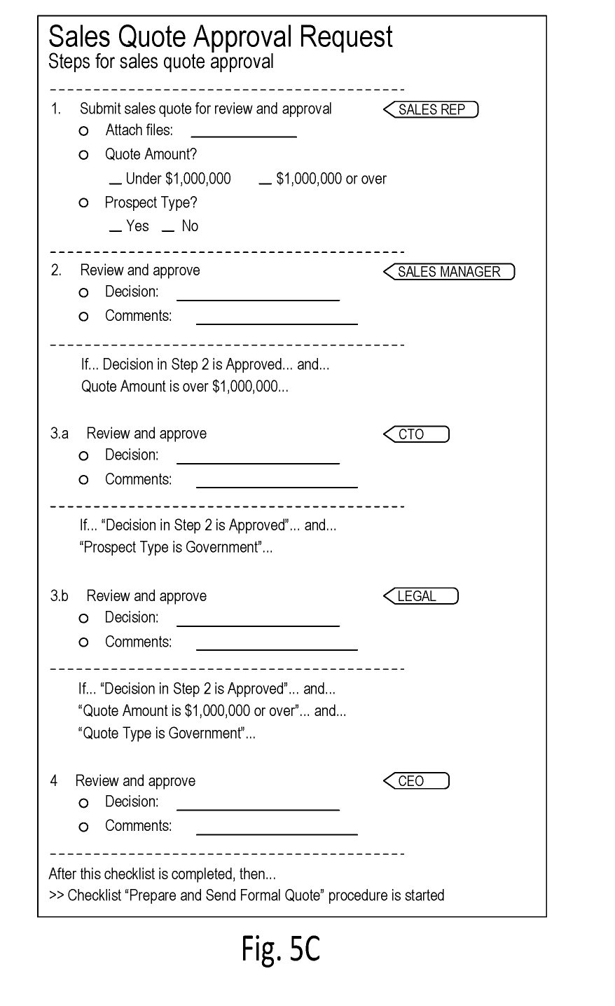

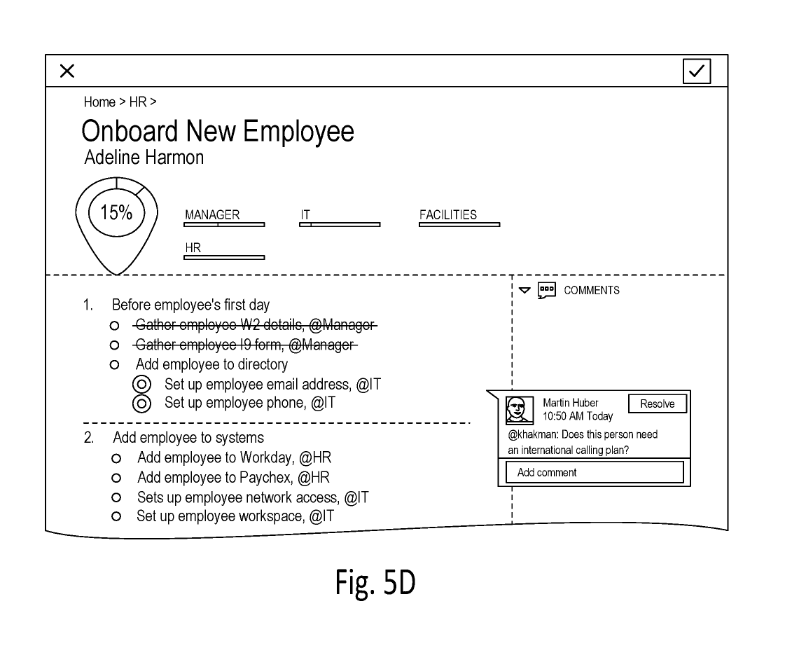

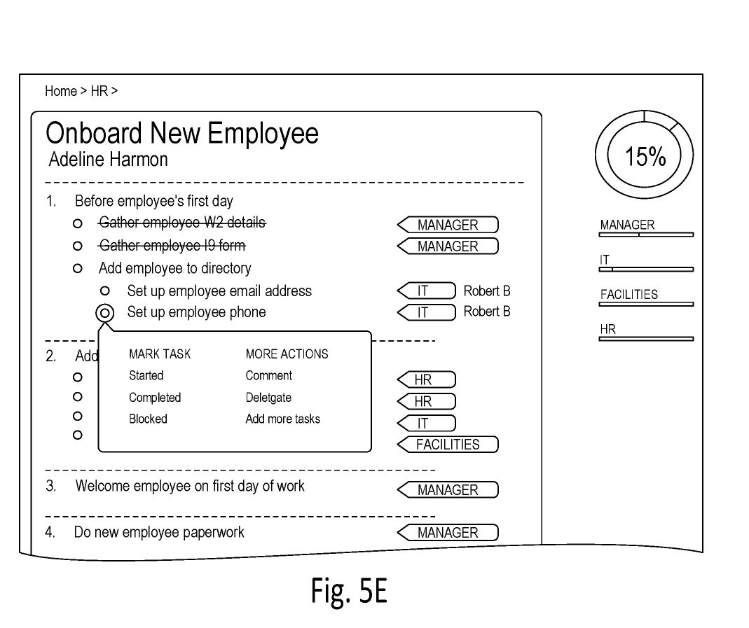

FIGS. 5A-5E are additional examples of the collaborative user interface generated by the collaborative hierarchical list editor, in accordance with various embodiments. In these embodiments, certain attributes of line items and the hierarchical checklist are visually styled. For example, the “@” assignment attribute is styled in a shape and positioned in a virtual column; the sequential process steps are separated by a horizontal line. In neither case does the visual formatting change the structure of the hierarchical checklist. However, the visual formatting does aid in the presentation to a person.

The collaborative user interface enables an author to define a process including unordered procedural steps and/or ordered procedural steps. Ordered and unordered procedural steps can then be automatically assigned to actors and enforced by the workflow orchestration engine. The orchestration engine can provide “stage gates” that forces a logical sequence of executing tasks. Completion of sub-tasks can be organized beneath another task are not “stage gates” in that the completion of the sub-tasks, not the parent task, cause the assignment of new tasks upon completion of the task.

In at least some of the examples, a hierarchical checklist includes in-line data entry (e.g., line items) written in natural language (e.g., according to template formatting convention). The line items can be in-line decision gates (see e.g., FIG. 5C showing a sales approval process with data entry). FIG. 5C illustrates several approval decisions, and several decision gates. For example, the term “if . . . ” in aggregate can be a symbol denoting the decision gate. FIG. 5C further illustrates linking hierarchical checklists and triggering another hierarchical checklists.

### Features of the Workflow Orchestration Engine and the Collaborative Hierarchical List Editor

The collaborative user interface can be configured to collect information that supplements the status of a work item in a hierarchical checklist. For example, the collaborative user interface enables an author or an actor to append data to a work item within the hierarchical checklist such that the supplemental information for a work item is associated in context of the workflow for which it is a part.

In conventional workflow management systems and SOP reference manuals, a manager often must author a workflow that anticipates all possible paths of the workflow in advance (e.g., a state model). However, the collaborative hierarchical list editor enables adaptation of the workflow just-in-time as needed and as determined by the workflow participants. Consider that if a group of people were working to accomplish a set of tasks and communicating by email, they may follow certain process steps as needed since email is flexible in that way. The flexibility of email however also means the collaborators may not follow the process they should follow. Email as well as task assignment systems generally lack a scaffolding to enforce the process the participants should follow to orchestrate the participants in those steps.

The collaborative workflow system provides the scaffolding of the workflow that they SHOULD follow yet can allow for just-in-time adaptation of the actual workflow procedures to handle cases such a “send back for review”, “go back to this point in the procedure and do it again”, “I′d like to get another review of the information from a new participant in the process”, “get an additional approval before proceeding” etc. Models created by the conventional workflow management systems (e.g., “business process management systems”) are pre-determined and inflexible, such that users must follow pre-determined paths. The disclosed hierarchical checklist (e.g., using one or more types of specialized bullets) can evolve in real-time and thus enable its actors and/or authors to decide whether they are “going back” to a point in the process/workflow. This feature can further enable actors and/or authors to redo steps and/or augment the process with new steps. Similarly in a case where the hierarchical checklist requires a “sign-off” by a manager, a member of the team using the list might decide to add an additional “sign-off” to the hierarchical checklist by another manager to assure this particular instance of the process gets additional acceptance due to its nuances. While the hierarchical checklist is evolving, the workflow orchestration engine can continuously update the evolving workflow path to enforce by merging the edits and additions in real-time.

Conventional workflow management systems typically require that processes be defined in advance. The collaborative workflow system enables processes to be defined just-in-time as needed. For example, the following can be part of a hierarchical checklist:
a. case 1: send back to @Amy for revision
b. case 2: request more info from @Brent
c. case 3: additional approval requested from @Caroline

Conventional workflows follow established paths that are defined by a graph data structure having multiple nodes connected by one or more paths (e.g., directional edges). Information can change at the nodes along those paths. Stationary actors can be assigned to the nodes to load/update/unload information. In the conventional workflow management system, the paths are all defined ahead of time.

In the collaborative workflow system, actors can be dynamically assigned to perform load/update/unload operations on information. In the collaborative workflow system, the paths can be pre-defined, but can also be added to by the actors based on new information. For example, to “send information ‘back’ for revision” a new set of paths may be laid just in time to let the informational train to move forward and loop back to the “send back to” point. The workflow orchestration engine can analyze the hierarchical positioning of the tasks in the hierarchical checklist to generate a rollback path that does not break the logic of existing workflow. A series of informational operators can define an information set. That is, each informational operator can change its state relative to a timeline of a workflow instance. Each operator can be a different type of information container. The informational operators can be split such that the “operators” travel on parallel paths for parallel processing and then merged back together later in the process. The workflow orchestration engine can determine the availability of parallel paths by identifying parallel branches in the hierarchical checklist. It is possible so as to facilitate collaboration between actors acting on separate paths that information can exist on multiple parallel paths at once.

Various embodiments include the feature of the “just-in-time” laying of informational train track, so as to alleviate the need to define certain common aspects of procedures (like asking for comments, sending work back for revisions, asking for additional approvals) in advance of initiating the workflow. The hierarchical checklist can represent a primary process (e.g., the desired main path). However in some embodiments, the disclosed collaborative hierarchical list editor can permit secondary paths to be created and executed as needed, so as to fulfill the needs of workflow, collaborative and ad-hoc work patterns. The collaborative workflow system can achieve this while not making the “process map” overly complex by adding all possible paths through the workflow to the representation.

In the conventional workflow management systems, programmed data structures representing a workflow can only be iteratively updated (e.g., from version to version). The collaborative workflow system enables dynamic and real-time updates directly from creation to enforcement. The collaborative workflow system lets a human to easily adapt/amend/re-route the process at the moment needed. The collaborative workflow system can blend the “standard procedure” framework that guides the overall process with the dynamic procedural updates from human actors who are accomplishing the procedure. This satisfies the real needs for processes to flex and handle exceptions. In some embodiments, the decisions to allow a process to vary or not can itself be a work item tasked to the process owner, e.g., upon a “request to allow process variation” type event.

In some embodiments, information about work items are shown in cells at the intersection of rows and columns, similar to a spreadsheet. At least one of the columns or a collection of columns can be used to represent the primary hierarchy of the procedure. In the collaborative workflow system, the workflow orchestration engine can interpret, execute, and enforce the hierarchal structure, including the spreadsheet. In some embodiments, information about work items are shown in association with each other as configurable attributes pertaining to the work item or information.

In some embodiments, a work item in a hierarchical checklist can be a hyperlink to another hierarchical checklist, which might have different access controls on it. The work item can provide the context that a sub-process is part of the process and allow the details of a sub-process to not be shared with participants of the main-process. In some embodiments, a sub-process may be configured to repeat a certain number of times. The repeating may be in relation to a static value set. The repeating may be in relation to a value associated with, or entered into the hierarchical checklist.

In some embodiments, the disclosed editor can enable capturing or attaching of process related information in context of the hierarchical checklist. An author can associate an attached file or text with work items in the hierarchical checklist. The disclosed editor can facilitate data capture as part of the procedure. For example, a hierarchical checklist can include a data field into which a value is entered or from which it is selected. The hierarchical checklist can include an interactive element to attach a file. The disclosed editor can use device sensors to capture information related to the procedure, such as photo, geolocation, temperature, audio input, etc., into the hierarchical checklist. An author can enter in or select a value in an interactive element of a hierarchical checklist. The interactive element can be used to enforce a workflow path determined by the workflow orchestration engine. The interactive element can contain and persist a reference to information stored in another system so that that other information may be located in the future. When enforcing a hierarchical checklist, the disclosed editor can use any combination of the above features to organize together a collection of data entry activities into the hierarchical checklist.

In some embodiments, the disclosed editor implements a voice recognition module. The voice recognition module enables its author and actors to create, re-assign and do other manipulations to work items by voice input. The voice recognition module can translate the voice input into text. The voice recognition module can parse and format the text such that it is interpretable by the workflow orchestration engine.

In some embodiments, the disclosed editor implements a touchscreen. The touchscreen enables an author or an actor to manipulate work items utilizing touchscreen gestures. For example, swiping leftward can mark a work item as being done; swiping leftward with 2 fingers can indicate delegation or reassignment of a work item; and swiping rightward can indicate access to other actions.

In some embodiments, the workflow orchestration engine can assign a work item to an individual identified in the hierarchical checklist. In some embodiments, the workflow orchestration engine can assign a work item to a role within a team or organization identified in the hierarchical checklist. An author, actor or owner of the hierarchical checklist can then identify who will do the work based on the role. In some embodiments, the hierarchical checklist can identify a list of people to assign a work item. The workflow orchestration engine can assign the work item to a first volunteer (e.g., an actor voluntarily takes ownership) or first available actor (e.g., the workflow orchestration engine identifies the availability of actor). In some embodiments, the workflow orchestration engine can also assign a backup actor to a work item. In some embodiments, the workflow orchestration engine can assign the work item to the entire list of people, where any member of the list can see and take action on the work item.

In some embodiments, end users using the disclosed editor can zoom in or out to see or experience broader or narrower context of the hierarchical checklist. For example, the zoom can have 5 levels. At a scale of 3, the disclosed editor can display the hierarchical checklist (e.g., scrolls through the hierarchical checklist if the screen is not sufficiently large enough). At a scale of 5, the disclosed editor can display relationships between hierarchical checklists as broader processes in relation to one another. That is, the hierarchical checklists themselves can be organized in a hierarchy as well. At a scale of 1, the disclosed editor can display a single work item and any detail or context associated with the work item.

In some embodiments, the workflow orchestration engine can task out work to other network connected applications (e.g., in addition to or instead of people and/or their devices). For example, a third-party application can facilitate automated processes. A work item (e.g., a procedure step) can be performed by the third-party application in part or entirely (e.g., without human action). For example, the workflow orchestration engine can automatically invoke the API of a third-party application or a third-party application service to perform a computerized or machine-implemented task. The third party application can then report back to the engine that the task was completed, or other possible states for the work, events upon which the engine can take further action to orchestrate the process.

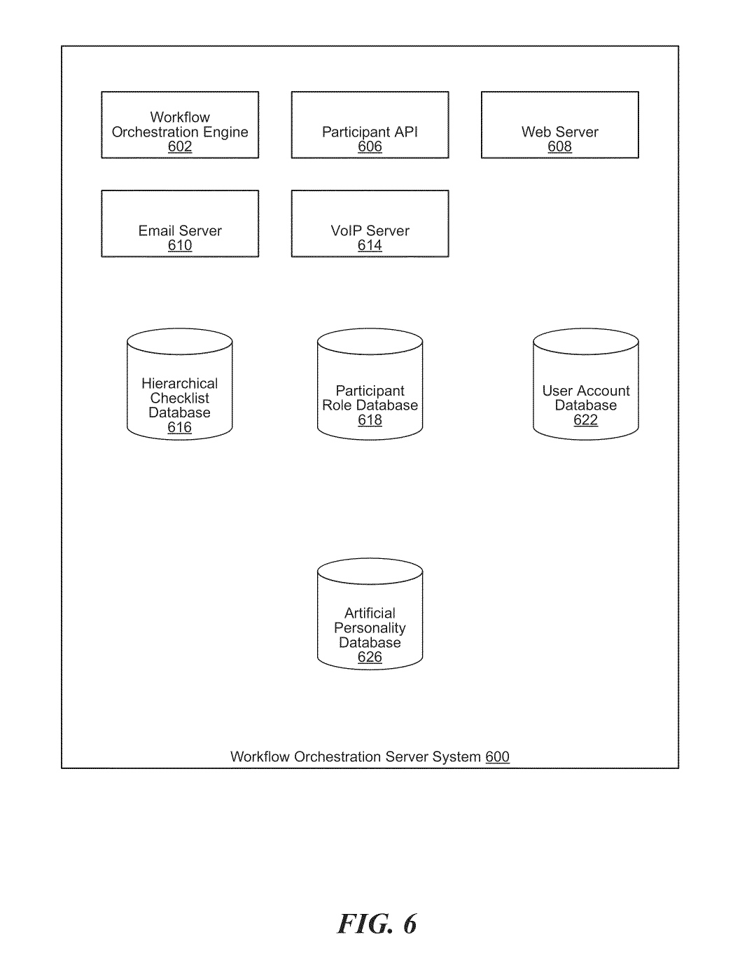

FIG. 6 is a block diagram of a workflow orchestration server system 600 (e.g., the computing device 112), in accordance with various embodiments. The workflow orchestration server system 600 can include one or more computing devices. The workflow orchestration server system 600 can include a workflow orchestration engine 602 (e.g., the workflow orchestration engine 114), a participant application programming interface (API) 606, a web server 608, an email server 610, a voice over Internet protocol (VoIP) server 614, a hierarchical checklist database 616, a participant role database 618, a user account database 622, an artificial personality database 626, or any combination thereof. The participant API 606 can expose the workflow orchestration engine 602 over a network (e.g., local area network and/or wide area network) to be accessed by one or more participant devices. For example, the participant devices can run an application configured to correspond with the participant API 606. The participant API 606 can provide (e.g., via data pushes or responsive to polling from the participant device) notifications to the participant devices.

The Web server 608, the email server 610, and/or the VoIP server 614 can expose (e.g., similarly to the participant API 606) the workflow orchestration engine 602 to one or more participant devices. The Web server 606 can expose at least a portion of computer-implemented services of the workflow orchestration engine 602 utilizing hypertext transport protocol (HTTP) or other protocol(s) accessible via web browsers. The email server 610 can expose at least a portion of the computer implemented services of the workflow orchestration engine 602 by communicating with the participant user accounts via email communication. The VoIP server 614 can expose at least a portion of the computer implemented services of the workflow orchestration engine 602 by communicating with the participant user accounts over a phone line or other audio-based telecommunication channel. For example, the VoIP server 614 can interpret participant's audio interactions with the workflow orchestration engine 602 utilizing speech recognition. Similarly, any textual notification from the workflow orchestration engine 602 can be synthesized using text-to-speech technology.

The workflow orchestration engine 602 can maintain and store one or more workflows represented by one or more hierarchical checklists. The workflow orchestration engine 602 can maintain and store one or more workflow templates represented by one or more hierarchical checklist templates. In some embodiments, the workflow orchestration engine 602 does not differentiate between a hierarchical checklist template and a hierarchical checklist (e.g., both are represented by natural language text segments according to the same format convention). The hierarchical checklist database 616 can store the hierarchical checklists and/or hierarchical checklist templates.

In an authoring stage of a workflow, the workflow orchestration engine 602 enables owners of a hierarchical checklist to edit and comment on the hierarchical checklist without enforcing execution of the hierarchical checklist. When transitioning to an execution stage, the workflow orchestration engine 602 can generate a hierarchical workflow execution model by parsing the natural language text segment representing the hierarchical checklist. The hierarchical checklist, for example, can indicate which of one or more participant roles are assigned to one or more task items represented therein. During the execution stage, the workflow orchestration engine 602 can determine from the participant role database 618 which user accounts belong to which participant roles. The user account database 622 can provide additional information associated with these user accounts. For example, the user account database 622 can specify one or more communication protocols/channels that can be used to communicate with each of the user accounts. The user account database 622 can also provide destination identifiers and/or device identifiers associated with these communication protocol/channels.

In some embodiments, the workflow orchestration engine 602 implements an artificial personality of a workflow coordinator. The workflow orchestration engine 602 can access the artificial personality database 626 to extract an artificial personality profile. The workflow orchestration engine 602 can configure the computer implemented workflow coordinator according to the artificial personality profile. The artificial personality profile can affect the lexicon used in notifications, frequency of notifications, communication channel preference for notifications, other characteristics for user interactions associated with enforcing the execution of the workflow represented by the hierarchical checklist.

In various embodiments, the workflow coordinator implemented by the workflow orchestration engine 602 utilizes artificial intelligence (e.g., machine learning and/or statistical analysis to enhance the utility of the workflow orchestration engine 602. The artificial intelligence can adapt/modify workflow orchestration rules of the workflow orchestration engine 602 by utilizing one or more machine learning algorithms. In at least one example, a machine learning algorithm can train a machine learning model for participant behavior of a participant user. In turn, the artificial intelligence can utilize the machine learning model to suggest task assignment to an owner of a hierarchical checklist associated with the participant user. Alternatively, the artificial intelligence can automate task assignment based on the machine learning model. In at least one example, a machine learning algorithm can train a machine learning model for progression behaviors of a workflow represented by a hierarchical checklist template or a hierarchical checklist. In turn, the artificial intelligence can utilize the machine learning model to automate tasks scheduling based on the progression behaviors of various participant roles.

For example, the workflow orchestration engine 602 can access a participant user's correspondence (e.g., email or other electronic messages) with the workflow orchestration engine 602 and the participant user's calendar systems (e.g., via the participant API 606). In some embodiments, the workflow orchestration engine 602 can have access to all messages or a subset of all messages of the participant user (e.g., via the participant API 606), regardless of whether the messages are correspondence with the workflow orchestration engine 602.

In one example, the artificial intelligence of the workflow coordinator can utilize natural language parsing to learn that a participant user is on vacation and proactively advise the manager/owner of a hierarchical checklist that a replacement needs to be found to keep to the target timeline. In another example, the artificial intelligence of the workflow coordinator can suggest, to a participant user, good times in the participant user's schedule to perform certain activities or tasks. In some examples, the artificial intelligence of the workflow coordinator can detect progress is slower relative to past performance and raise the potential issue to the managing user and/or owner user of the hierarchical checklist. In other examples, the artificial intelligence can facilitate task notification, availability of interactive elements, and workflow-related communication style and content based on historical behavior and statistic learned from analyzing the hierarchical checklist database 616, the participant role database 618, the user account database 622, or any combination thereof. The artificial intelligence features can mimic/emulate behavior of a human process coordinator and perform at least a few tasks of the human process coordinators are incapable of performing because humans cannot store, recall and process the volume of information necessary for such insights.

Functional components (e.g., circuits, devices, engines, modules, and data storages, etc.) associated with the collaborative workflow system 100 and/or the workflow orchestration server system 600 can be implemented as a combination of circuitry, firmware, software, or other functional instructions. For example, the functional components can be implemented in the form of special-purpose circuitry, in the form of one or more appropriately programmed processors, a single board chip, a field programmable gate array, a network-capable computing device, a virtual machine, a cloud computing environment, or any combination thereof. For example, the functional components described can be implemented as instructions on a tangible storage memory capable of being executed by a processor or other integrated circuit chip. The tangible storage memory may be volatile or non-volatile memory. In some embodiments, the volatile memory may be considered “non-transitory” in the sense that it is not a transitory signal. Memory space and storages described in the figures can be implemented with the tangible storage memory as well, including volatile or non-volatile memory.

Each of the functional components may operate individually and independently of other functional components. Some or all of the functional components may be executed on the same host device or on separate devices. The separate devices can be coupled through one or more communication channels (e.g., wireless or wired channel) to coordinate their operations. Some or all of the functional components may be combined as one component. A single functional component may be divided into sub-components, each sub-component performing separate method step or method steps of the single component.

In some embodiments, at least some of the functional components share access to a memory space. For example, one functional component may access data accessed by or transformed by another functional component. The functional components may be considered “coupled” to one another if they share a physical connection or a virtual connection, directly or indirectly, allowing data accessed or modified by one functional component to be accessed in another functional component. In some embodiments, at least some of the functional components can be upgraded or modified remotely (e.g., by reconfiguring executable instructions that implements a portion of the functional components). The systems, engines, or devices described may include additional, fewer, or different functional components for various applications.

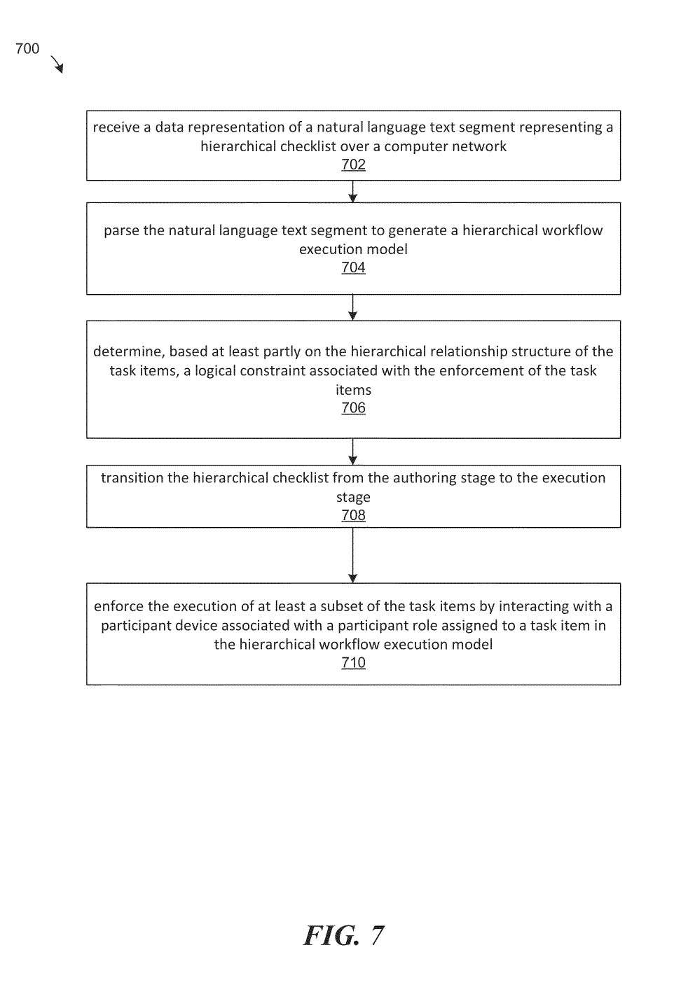

FIG. 7 is a method 700 of operating a collaborative workflow system (e.g., the collaborative workflow system 100) to define a workflow associated with a hierarchical checklist, in accordance with various embodiments. At step 702, a workflow orchestration server system (e.g., the workflow orchestration server system 600 implemented by one or more of computing devices 400) can receive a data representation of a natural language text segment representing a hierarchical checklist over a computer network. In some embodiments, the workflow orchestration server system can receive the data representation of the natural language text segment as part of an email at an email server (e.g., the email server 610) associated with the workflow orchestration server system. In some embodiments, the workflow orchestration server system can receive (e.g., via the participant API 606, the email server 610, the VoIP server 614, etc.) the data representation of the natural language text segment from a computing device running a checklist editor application that enforces a format convention associated with hierarchical checklist.

At step 704, the workflow orchestration server system can parse the natural language text segment to generate a hierarchical workflow execution model. This parsing step can occur in response to receiving the natural language text segment. The hierarchical workflow execution model can be a machine-formatted representation of the hierarchical checklist that is capable of bi-directional translation. For example, the machine formatted representation can be based on JavaScript object notation (JSON). The bi-directional translation can be between the machine-formatted representation and the natural language text segment.

The hierarchical workflow execution model can specify a plurality of task items corresponding to one or more line items (e.g., a line of text) in the natural language text segment (e.g., representative of the hierarchical checklist). The natural language text segment can specify one or more participant roles assigned to at least a subset of the task items. The line items of the natural language text segment can include textual tokens (e.g., prefix tokens and/or suffix tokens) in the line items. The textual tokens can denote a hierarchical relationship structure (e.g., a tree structure) of the line items and therefore the task items. For example, the textual tokens can be a bullet, a symbol (e.g., corresponding to a specific bullet type), a keyword, a tab, or any combination thereof. In some embodiments, a task item can be part of a hierarchical grouping of task items and sub-task-items. For example, a “child task item” can be part of a “parent task item,” and the “parent task item” can be part of a “grandparent task item.” Based on the hierarchical relationship structure, the workflow orchestration server system can automatically assigned any unassigned task item according to the role assignment of its immediate ancestral task item (e.g., a task item closest to and above the unassigned task item in a branch of the hierarchical relationship structure).

In some embodiments, each of the line items includes a textual token, a task description, a task condition subsequent, a task condition precedent, a role assignment, or any combination thereof. In some embodiments, a textual token can dictate format of a line item including where the task description and/or the role assignment are at relative to positions in the line item. In some embodiments, a textual token of a line item can dictate a task type and/or a logical constraint associated with a task item that is associated with the line item.

In some embodiments, the workflow orchestration server system can parse the natural language text segment against a format convention (e.g., the format convention enforced by the checklist editor application) to identify a format convention violation. The format convention can dictate one or more text format requirements that need to be satisfied for the natural language text segment to be valid. The format convention can be maintained as a set of textual constraints stored in the workflow orchestration server system.

In some embodiments, the workflow orchestration server system can parse the natural language text segment to detect an error or a potential error in the hierarchical checklist. For example, the workflow orchestration server system can detect the error or potential error by comparing one or more patterns (e.g., represented by regular expressions) in an error pattern database to the natural language text segment and/or the hierarchical relationship structure In some embodiments, the workflow orchestration server system can generate a suggested modification to fix the error. For example, the error pattern database can include a suggested modification associated with a known error or potential error. In some embodiments, the workflow orchestration server system can notify an owner user of the hierarchical checklist to modify the natural language text segment in response to detecting the error or potential error. The workflow orchestration server system can also provide the suggested modification to the owner of the hierarchical checklist. When the workflow orchestration server system receives an email to provide or update the natural language text segment, the workflow orchestration server system can generate a reply email to a sender address of the email. The reply email can annotate a region of the natural language text segment that violates the format convention.

At step 706, the workflow orchestration server system can determine, based at least partly on the hierarchical relationship structure of the task items, a logical constraint associated with the enforcement of the task items. The logical constraint can be a sequential relationship constraint (sequential task items denoted by numbered line items), an assignment role constraint (participant role assignment to one level of the hierarchical relationship structure, including one or more task items), a co-ownership constraint (assignment of one or more task items to two or more participant roles or a single participant role with two or more user accounts associated therewith), a mutual exclusivity constraint (e.g., denoted by textual tokens in line items on the same hierarchical level, the textual tokens signifying alternative task items), a co-occurrence constraint (e.g., denoted by textual tokens in line items on the same hierarchical level, the textual tokens signifying corresponding task items that are to be completed at the same time), a parallelism constraint (e.g., denoted by unordered textual tokens in line items on the same hierarchical level, signifying capability to perform the corresponding task items in parallel), a rollback capability constraint (e.g., a textual token in a line item denoting a corresponding task item's capability to or restriction from being redone/rolled-back), a conditional constraint (e.g., a textual token in a line item denoting that a corresponding task item is only applicable when a data entry by or associated with a participant satisfies a condition), or any combination thereof, applicable to at least one of the task items.

In some embodiments, each of the hierarchical checklist can be operated in at least two modes/stages, an authoring stage and an execution stage. Steps 702-706 occur in the authoring stage. In the authoring stage, the workflow orchestration server system receives initial definition of hierarchical checklist and generates the hierarchical workflow execution model without executing the task items. For example, the definition includes defining task items and assigning participant roles (e.g., users, groups of users, category of users, etc.) responsible for completing the task items. During the authoring stage, the workflow orchestration server system can collect comments from co-owners and/or participants of the hierarchical checklist. The user interface of the authoring stage can display these comments to facilitate collaborative authorship. The workflow orchestration server system can remove these comments in the hierarchical checklist, in response to a transition from the authoring stage to the execution stage.

In the execution stage, the workflow orchestration server system enforces the execution of the task items by: automatically assigning the task items, tracking progress statuses of the task items, notifying users assigned to the task items, re-configuring the task items (e.g., runtime authoring), modifying the hierarchical checklist, regenerating the hierarchical workflow execution model, managing calendars of the users assigned to the task items, or any combination thereof. In some embodiments, during the execution stage, the role assignments made during the authoring stage enables the workflow orchestration server system to manage access control of the task items or data associated with the task items (e.g., user uploaded or user entered data) based on the hierarchical relationship structure.

In some embodiments, the workflow orchestration server system can generate a user interface (e.g., a checklist editor application running on the participant device) for the authoring stage and a different user interface for the execution stage. In some embodiments, the workflow orchestration server system can use the same user interface for the authoring stage and the execution stage.

At step 708, the workflow orchestration server system can transition the hierarchical checklist from the authoring stage to the execution stage. At step 710, the workflow orchestration server system can enforce the execution of at least a subset of the task items by interacting with a participant device associated with a participant role assigned to a task item in the hierarchical workflow execution model. The workflow orchestration server system can enforce the task items in accordance with the determined logical constraint. The logical constraint can dictate how the execution of the task item is to be enforced.

In some embodiments, as part of enforcing the execution of the task items, the workflow orchestration server system identifies, from a role database, an account profile associated with the participant role of the task item. In one example, the role database can map one or more account profiles for each participant role. The role database can be updated independent of the hierarchical checklist. This enables an enterprise company to update its personnel profile into known roles. The hierarchical checklist can remain applicable despite turnover in the enterprise company. For example, a new employee hired into an engineering department can be separately updated in the role database without needing to update a hierarchical checklist that assigns a task to an “engineer role.” The user account profile can include and specify a communication protocol and a destination identifier associated with the participant device of the account profile. The workflow orchestration server system can notify, via the communication protocol and the destination identifier, the participant device of the account profile to update the status of the task item.

In some embodiments, as part of enforcing the execution of the task items, the workflow orchestration server system configures a user interface in the participant device to display at least a portion of the natural language text segment representative of the hierarchical checklist. The workflow orchestration server system can determine what portion of the natural language text segment to display based on the participant role assigned to the task item. In some embodiments, the configuration of the user interface is made to be consistent with and according to the logical constraint in the event that the logical constraint involves the task item. The workflow orchestration server system can further configure the user interface to display an interactive element for a user to update the status of the task item or to accept the task item assigned to the user. The user interface can be associated with the participant role of the participant device. A status update can include approving or rejecting an assignment of the task item. The status update can include indicating completion, pendency, and/or delay in the performance/execution of the task item. The status update can include a need to redo a completed task item. In some embodiments, during an authoring stage of the hierarchical checklist, an authoring user can embed a data entry request or an attachment request. During the execution stage in these embodiments, the workflow orchestration server system configures the user interface with a data entry field or an attachment field (e.g., as the interactive element). For example, the users interface can receive data entry and file attachment attached with the task item as part of the status update.

In some embodiments, the workflow orchestration server system can configure, according to the hierarchical checklist, user interfaces on different participant devices associated with different participant roles differently. For example, in response to receiving an update to the task item from the participant device, the workflow orchestration server system can reconfigure another instance of a user interface on a different participant device for a different participant role according to the hierarchical workflow execution model.

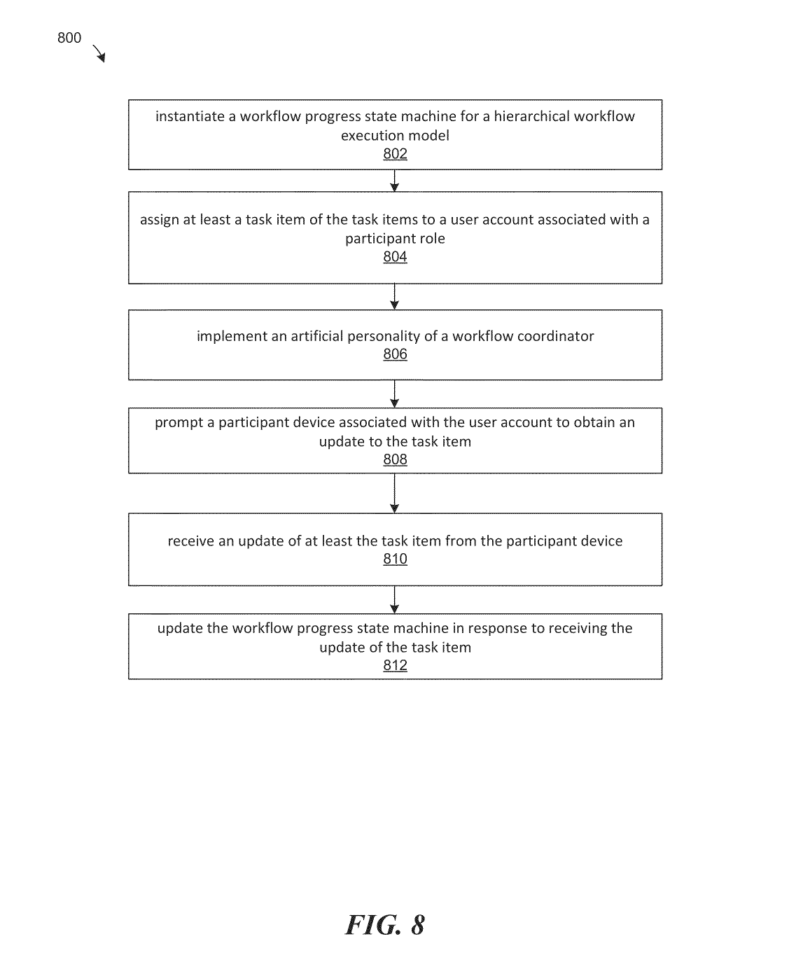

FIG. 8 is a method 800 of operating a collaborative workflow system (e.g., the collaborative workflow system 100) to execute a workflow associated with a hierarchical checklist, in accordance with various embodiments. At step 802, a workflow orchestration server system (e.g., the workflow orchestration server system 600) can instantiate a workflow progress state machine for a hierarchical workflow execution model (e.g., the hierarchical workflow execution model defined in the method 700). For example, the hierarchical workflow execution model can be derived from a natural language text segment representative of a hierarchical checklist. The hierarchical workflow execution model can specify a plurality of task items corresponding to one or more line items in the natural language text segment. At least a subset of the task items can be respectively assigned to one or more participant roles. The textual tokens of the line items can denote a hierarchical relationship structure of the task items. For example, the workflow progress state machine includes a state corresponding to a task item. The state is then updatable by the participant role assigned to the task item.

At step 804, the workflow orchestration server system can assign at least a task item of the task items to a user account associated with a participant role. The natural language text segment can denote an assignment of the task item or an ancestral task item (e.g., another task item that is directly above the task item according to the hierarchical relationship structure) to the participant role. The workflow orchestration server system can determine the assignments of the task items automatically according to the hierarchical relationship structure.

At step 806, the workflow orchestration server system can implement an artificial personality of a workflow coordinator. The artificial personality can be configured to interact, via natural language (e.g., computer synthesized spoken language or computer synthesized text), with user accounts assigned to the task items. The artificial personality can enforce the execution of the task items or to facilitate authoring and/or modification of the hierarchical checklist. In some embodiments, the workflow orchestration server system can be a web-based interface or an email server configured to expose the artificial personality for interaction with the participant devices associated with the participant roles. The hierarchical checklist can be associated with a single artificial personality or multiple artificial personalities respectively chosen for each user account associated with the participant roles. The artificial personality can be configured with a language and/or a personality profile. The personality profile can dictate the lexicon (e.g., terms, phrases, tone, gender, engagement, humor, etc.) of the natural language used by the computer-implemented workflow coordinator. For example, in an event that the computer implemented workflow coordinator is given a choice of multiple potential interaction/responses with to accomplish the same things, the personality profile can facilitate the computer implemented workflow coordinator choose which options to pursue. For example, the artificial personality can choose to use humor-configured, sincerity-configured, or sternness-configured lexicon when notifying a user account to accomplish its assigned task item.

At step 808, the workflow orchestration server system can prompt a participant device associated with the user account to obtain an update to the task item. In some embodiments, the workflow orchestration server system can utilize the artificial personality to prompt the participant device. In at least one example, a bullet type of a prefix token in the line item corresponding to the task item can correspond to an inquiry task. The workflow orchestration server system can identify the bullet type to identify the inquiry task. In this example, prompting the participant device can include requesting an additional task item or input of additional information from the participant device according to the inquiry task. In another example, the workflow orchestration server system can identify an idle session associated with the participant role by analyzing an electronic calendar of the participant role or the activity of a user interface running on the participant device. The workflow orchestration server system can notify the participant role to complete the task item or update the status of the task item in response to identifying the idle session. In some embodiments, the workflow orchestration server system can access the electronic calendar directly via an API coupled to an application installed on the participant device or via an API coupled to a cloud-based calendar service run by another server system. In several embodiments, the workflow orchestration server system can provide one-on-one task completion scheduling assistance utilizing the exposure of the electronic calendar of the participant role.

In various embodiments, the workflow orchestration server system can consolidate a plurality of notifications/prompts into a single message to a participant device. For example, these notifications/prompts can be generated according to the current state of the workflow progress state machine and/or the hierarchical relationship structure. Batching/consolidation of the plurality of notifications advantageously enables the workflow orchestration server system to reduce the amount of unnecessary interactions with individual participants assigned to the task items. The notifications can correspond to different task items in different levels of the hierarchical relationship structure.

At step 810, the workflow orchestration server system can receive an update of at least the task item from the participant device. For example, step 810 can be responsive to a prompting message sent at step 808. The workflow orchestration server system can receive the update from a task enforcement user interface running on the participant device. The task enforcement user interface can be coupled to the workflow orchestration server system via a participant API. The updates can be a run-time variation including a task item approval or a task reset indication from the user account associated with the assigned participant role. An interactive element in the task enforcement user interface can detect a user response to update the task item. The workflow orchestration server system can configure the task enforcement user interface according to a logical restraint derived based on the hierarchical relationship structure.

At step 812, the workflow orchestration server system can update the workflow progress state machine in response to receiving the update of the task item. For example, the workflow orchestration server system can change a data access permission setting of the participant role to interact with at least one of the task items and its associated data according to a current state of the workflow progress state machine. In some embodiments, the workflow orchestration server system can update the hierarchical checklist and/or the hierarchical workflow execution model in response to the update. The update can involve processing and/or edit to the hierarchical checklist and/or hierarchical workflow execution model. The update can involve a status update of a task item (e.g., a task completion, a task assignment acceptance, a task redo, a task assignment rejection, a task delay, etc.).

In some embodiments, the workflow orchestration server system can receive a user indication to redo the task item at step 810. In response at step 812, the workflow orchestration server system can traverse the hierarchical relationship structure of the task items to update one or more states of a subset of the task items affected by said redoing of the task item. The workflow orchestration server system can identify task dependency and data access dependency associated with the task item to redo. Given this chain of dependency constraints, the workflow orchestration server system can mark the associated task items for redo as well.

In some embodiments, at step 810, the workflow orchestration server system can also track progress statistics associated with the task items or the participant roles (see FIG. 5E). For example, the progress statistics can include a percentage of task items assigned to a participant role that has the same status (e.g., of being completed or of being pending). For another example, the progress statistics can include a percentage of task items that has the same status in the same sub-hierarchy within the hierarchical relationship structure of the task items. In these embodiments, at step 812, the workflow orchestration server system can generate a recommendation to an authoring user or an owner user of the hierarchical checklist based on the progress statistics collected at step 810. The recommendation can specify a suggestion to modify the hierarchical checklist.

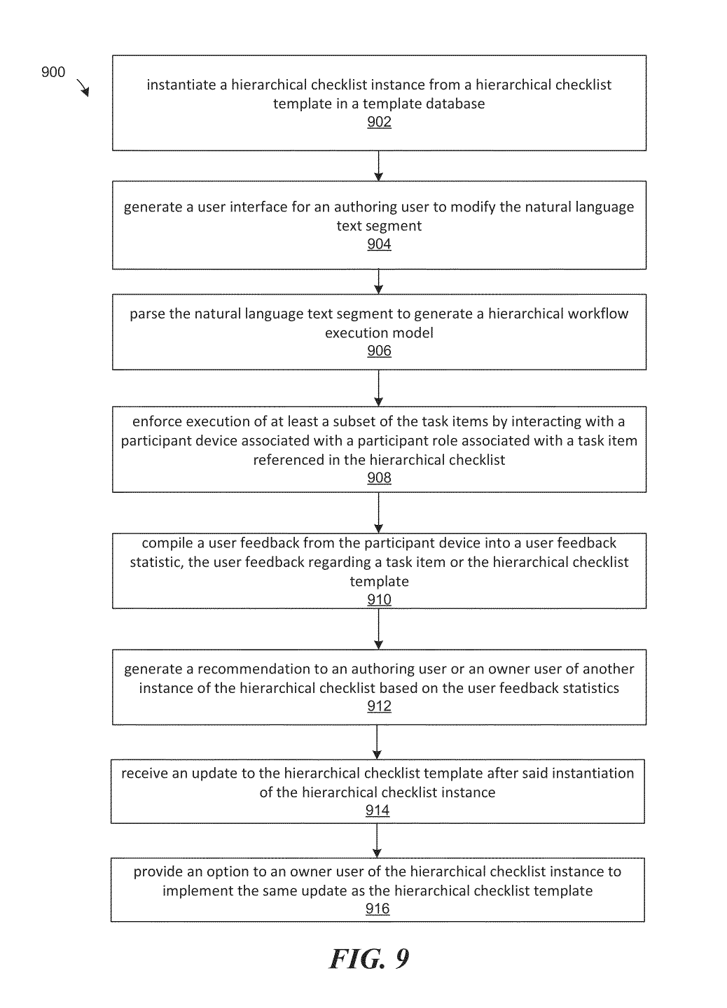

FIG. 9 is a method 900 of operating a collaborative workflow system (e.g., the collaborative workflow system 100) to manage hierarchical checklist templates, in accordance with various embodiments. At step 902, a workflow orchestration server system (e.g., the workflow orchestration server system 600) can instantiate a hierarchical checklist instance from a hierarchical checklist template in a template database. A hierarchical checklist template can be read and copy by user accounts other than its owner(s), but can only be edited by its owner(s). The instantiation of the hierarchical checklist instance can involve copying a natural language text segment associated with the hierarchical checklist template over to a new hierarchical checklist instance.

In some embodiments, a hierarchical checklist template can be readily available once it is copied into a new instance. In some embodiments, a hierarchical checklist template can include blank line items or fields to be filled in by a new owner of the new instance. In some embodiments, the new instance can be instantiated from two or more hierarchical checklist templates. In some embodiments, a hierarchical checklist template can represent a subroutine or a partial operating procedure within the new instance of the hierarchical checklist. A line item in the natural language text segment of a hierarchical checklist template can include at least a task item description, an attribute for a task item, a non-machine-interpretable comment, a logical condition associated with one or more task items, or any combination thereof.

At step 904, the workflow orchestration server system can generate a user interface for an authoring user to modify the natural language text segment. At step 906, the workflow orchestration server system can parse the natural language text segment to generate a hierarchical workflow execution model. The hierarchical workflow execution model can describe a plurality of task items corresponding to one or more line items in the hierarchical checklist. At least some of the task items can be respectively assigned to one or more participant roles. Textual tokens of the line items can denote a hierarchical relationship structure of the line items and therefore the task items.

At step 908, the workflow orchestration server system can enforce execution of at least a subset of the task items by interacting with a participant device associated with a participant role associated with a task item referenced in the hierarchical checklist. In some embodiments, as part of step 908, the workflow orchestration server system can receive an update to the hierarchical checklist instance. In some embodiments, the workflow orchestration server system can provide an option to an owner user of the hierarchical checklist template to implement the same update as an update to the hierarchical checklist instance.

At step 910, the workflow orchestration server system can compile a user feedback from the participant device into a user feedback statistic, the user feedback regarding a task item or the hierarchical checklist template. At step 912, the workflow orchestration server system can generate a recommendation to an authoring user or an owner user of another instance of the hierarchical checklist. For example, the recommendation can be based on the user feedback statistics. In some embodiments, the workflow orchestration server system can generate a comparison data structure (e.g., that highlights additions and replacements made from the original hierarchical checklist template to the updated hierarchical checklist instance).

At step 914, the workflow orchestration server system can receive an update to the hierarchical checklist template after said instantiation of the hierarchical checklist instance. In response at step 916, the workflow orchestration server system can provide an option to an owner user of the hierarchical checklist instance to implement the same update as the hierarchical checklist template. In some embodiments, the workflow orchestration server system can generate a comparison data structure (e.g., that highlights additions and replacements made from the hierarchical checklist instance to the updated hierarchical checklist template).

While processes or blocks are presented in a given order in this disclosure, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. In addition, while processes or blocks are at times shown as being performed in series, these processes or blocks may instead be performed in parallel, or may be performed at different times. When a process or step is “based on” a value or a computation, the process or step should be interpreted as based at least on that value or that computation. A process step is “in response to” to another process step when the process step is a direct reaction to the completion of the other process step.

The figures depict various embodiments of this disclosure for purposes of illustration only. One skilled in the art will readily recognize from the following discussion that alternative embodiments of the structures and methods illustrated herein may be employed without departing from the principles of embodiments described herein.

Some embodiments of the disclosure have other aspects, elements, features, and steps in addition to or in place of what is described above. These potential additions and replacements are described throughout the rest of the specification. Reference in this specification to “various embodiments” or “some embodiments” means that a particular feature, structure, or characteristic described in connection with the embodiment is included in at least one embodiment of the disclosure. Alternative embodiments (e.g., referenced as “other embodiments”) are not mutually exclusive of other embodiments. Moreover, various features are described which may be exhibited by some embodiments and not by others. Similarly, various requirements are described which may be requirements for some embodiments but not other embodiments.

What is claimed is:

1. A computer-implemented method, comprising:
receiving, by a workflow orchestration server system over a computing network, a data representation of a natural language text segment representing a hierarchical checklist;
parsing, by the workflow orchestration server system, the natural language text segment to generate a hierarchical workflow execution model, wherein the hierarchical workflow execution model describes a plurality of task items corresponding to one or more line items in the natural language text segment and respectively assigned to one or more participant roles, wherein textual tokens of the line items denotes a hierarchical relationship structure of the task items;
determining, by the workflow orchestration server system and based at least partly on the hierarchical relationship structure of the task items, a logical constraint associated with enforcement of the task items; and
enforcing, by the workflow orchestration server system, execution of at least a subset of the task items by interacting with a participant device associated with a participant role assigned to a task item in the hierarchical workflow execution model, wherein said enforcing is in accordance with the determined logical constraint.

2. The computer-implemented method of claim 1, wherein the hierarchical workflow execution model is a machine-formatted representation of the hierarchical checklist that is capable of bi-directional translation between the machine-formatted representation and the natural language text segment.

3. The computer-implemented method of claim 1, wherein each of the line items includes a textual token, a task description, a task condition subsequent, a task condition precedent, a role assignment, or any combination thereof and wherein the textual token is a symbol, a keyword, a tab, or any combination thereof.

4. The computer-implemented method of claim 1, wherein enforcing the execution of the task items includes:
identifying, from a role database, an account profile associated with the participant role of the task item, wherein the account profile includes a communication protocol and a destination identifier associated with the participant device of the account profile; and
notifying, via the communication protocol and the destination identifier, the participant device of the account profile to update a status of the task item.

5. The computer-implemented method of claim 1, wherein enforcing the execution of the task items includes:
configuring a user interface in the participant device to display at least a portion of the natural language text segment representative of the hierarchical checklist and an interactive element for a user to update a status of the task item or to accept the task item assigned to the user.

6. The computer-implemented method of claim 1, further comprising: in response to receiving an update to the task item from the participant device, re-configuring another instance of a collaborative user interface on a different participant device for a different participant role according to the hierarchical workflow execution model.

7. The computer-implemented method of claim 1, wherein receiving the data representation of the natural language text segment is by receiving an email at an email server associated with the workflow orchestration server system.

8. The computer-implemented method of claim 7, wherein parsing the natural language text segment includes parsing the natural language text segment against a format convention to identify a format convention violation; and further comprising:
generating a reply email to a sender address of the email, the reply email annotating a region of the natural language text segment that violates the format convention.

9. The computer-implemented method of claim 1, wherein receiving the data representation of the natural language text segment from a computing device running a checklist editor application that enforces a format convention associated with hierarchical checklist.

10. The computer-implemented method of claim 1, wherein the logical constraint is a sequential relationship constraint, an assignment role constraint, a co-ownership constraint, a mutual exclusivity constraint, a co-occurrence constraint, a parallelism constraint, a rollback capability constraint, a conditional constraint, or any combination thereof, applicable to at least one of the task items.

11. The computer-implemented method of claim 1, wherein said parsing the natural language text segment to generate the hierarchical workflow execution model occurs in an authoring stage configured to establish the hierarchical workflow execution model without executing the task items; and wherein said enforcing the execution of the task items occurs in a deployment stage configured to automatically assign the task items, track progress of the task items, re-configure the task items, modify the hierarchical workflow execution model, or any combination thereof.

12. The computer-implemented method of claim 1, wherein said parsing the natural language text segment includes detecting an error or a potential error in the hierarchical checklist, and further comprising:
notifying an owner user of the hierarchical checklist to modify the natural language text segment.

13. The computer-implemented method of claim 1, further comprising:
implementing an artificial personality of a workflow coordinator via the workflow orchestration server system, wherein the artificial personality is configured to interact, via natural language, to enforce the execution of the task items or to author or modify the hierarchical checklist; and
implementing a web-based interface or an email server configured to expose the artificial personality to interact with the participant devices associated with the participant roles.

14. The computer-implemented method of claim 1, further comprising:
receiving a user indication to redo the task item; and
traversing the hierarchical relationship structure of the task items to update one or more states of a subset of the task items that would be affected by redoing of the task item.

15. The computer-implemented method of claim 1, further comprising:
tracking progress statistics associated with the task items or the participant roles; and
generating a recommendation to an authoring user or an owner user of the hierarchical checklist based on the progress statistics, the recommendation specifies a suggestion to modify the hierarchical checklist.

16. A computer-readable storage memory apparatus storing computer-executable instructions, comprising:
instructions for parsing, by a workflow orchestration server system, a natural language text segment representative of a hierarchical checklist to generate a hierarchical workflow execution model including a workflow progress state machine, wherein the hierarchical workflow execution model describes a plurality of task items corresponding to one or more line items in the natural language text segment and respectively assigned to one or more participant roles, wherein textual tokens of the line items denote a hierarchical relationship structure of the task items;
instructions for assigning, by the workflow orchestration server system, at least a task item of the task items to a user account associated with a participant role, wherein the natural language text segment denotes the participant role being assigned to the task item or an ancestral task item of the task item according to the hierarchical relationship structure;
instructions for prompting a participant device associated with the user account to obtain an update to the task item; and
instructions for updating the workflow progress state machine in response to receiving the update of the task item from the participant device.

17. The computer-readable storage memory apparatus of claim 16, further comprising:
instructions for identifying a bullet type of a prefix token to the line item corresponding to the task item, wherein the bullet type corresponds to an inquiry task; and
wherein said prompting the participant device includes requesting an additional task item or input of additional information from the participant device according to the inquiry task.

18. The computer-readable storage memory apparatus of claim 16, further comprising:
instructions for identifying an idle session associated with the participant role by analyzing an electronic calendar of the participant role; and
instructions for notifying the participant role to complete the task item, in response to identifying the idle session.

19. The computer-readable storage memory apparatus of claim 16, further comprising:
instructions for changing permission setting of the participant role to interact with at least one of the task items according to the workflow progress state machine tracked by the hierarchical orchestration server system.

20. The computer-readable storage memory apparatus of claim 16, wherein the workflow progress state machine includes a state corresponding to the task item, wherein the state is updatable by the participant role assigned to the task item.

21. The computer-readable storage memory apparatus of claim 16, further comprising instructions to consolidate a plurality of task assignments or notifications into a single message to a participant device.

22. A server system, comprising:
one or more processors;
a computer readable memory storing executable instructions, wherein the processors, when configured by the executable instructions, are operable to:
instantiate a hierarchical checklist instance from a hierarchical checklist template in a template database, wherein the hierarchical checklist instance is instantiated with a natural language text segment;
generating a user interface for an authoring user to modify the natural language text segment;
parsing the natural language text segment to generate a hierarchical workflow execution model, wherein the hierarchical workflow execution model describes a plurality of task items corresponding to one or more line items in the hierarchical checklist and respectively assigned to one or more participant roles, wherein a hierarchical relationship structure of the line items are denoted by prefix tokens of the line items; and
enforcing execution of at least a subset of the task items by interacting with a participant device associated with a participant role associated with a task item referenced in the hierarchical checklist.

23. The server system of claim 22, wherein a line item within the line items includes at least a task item description, an attribute for a task item, a non-machine-interpretable comment, a logical condition associated with one or more task items, or any combination thereof.

24. The server system of claim 22, wherein the processors, when configured by the executable instructions, are operable to:
compile a user feedback from the participant device into a user feedback statistic, the user feedback regarding a task item or the hierarchical checklist template; and
generate a recommendation to an authoring user or an owner user of another instance of the hierarchical checklist based on the user feedback statistics.

25. The server system of claim 22, wherein the processors, when configured by the executable instructions, are operable to:
receive an update to the hierarchical checklist instance; and
providing an option to an owner user of the hierarchical checklist template to implement the update of the hierarchical checklist instance to the hierarchical checklist template.

26. The server system of claim 22, wherein the processors, when configured by the executable instructions, are operable to:
receive an update to the hierarchical checklist template after said instantiating of the hierarchical checklist instance; and
providing an option to an owner user of the hierarchical checklist instance to implement the update of the hierarchical checklist template to the hierarchical checklist instance.
